(19) United States
(12) Patent Application Publication
(10) Pub. No.: US 2015/0055062 A1
(43) Pub. Date: Feb. 26, 2015

(54) OPTICAL FILM, POLARIZER AND LIQUID CRYSTAL DISPLAY DEVICE

(71) Applicant: FUJIFILM Corporation, Tokyo (JP)

(72) Inventors: Yoshiaki HISAKADO, Kanagawa (JP); Masato NAGURA, Kanagawa (JP); Jun NOGUCHI, Kanagawa (JP); Kazuya HISANAGA, Kanagawa (JP); Nobutaka FUKAGAWA, Kanagawa (JP); Yu NAITO, Kanagawa (JP); Hiromichi FURUKAWA, Kanagawa (JP)

(73) Assignee: FUJIFILM Corporation, Tokyo (JP)

(21) Appl. No.: 14/537,376

(22) Filed: Nov. 10, 2014

Related U.S. Application Data
(63) Continuation of application No. PCT/JP2013/062708, filed on May 1, 2013.

(30) Foreign Application Priority Data
May 11, 2012 (JP) 2012-109769
Mar. 14, 2013 (JP) 2013-052316

(51) Int. Cl. G02B 5/30; G02F 1/1343; G02B 1/08; G02F 1/1335

(52) U.S. Cl. CPC G02B 5/3083; G02F 1/133528; G02F 1/134363; G02B 1/08
USPC 349/96; 359/489.07

(57) ABSTRACT

An optical film, has a film thickness of 15 μm to 45 μm, Rth (440 W, 30% RH) and “Rth (440 W, 30% RH)−Rth (440 W, 80% RH)” of the optical film satisfy Expression (1) −20 nm≦Rth (440 W, 30% RH)≦5 nm and Expression (2) 0 nm≦Rth (440 W, 30% RH)−RH (440 W, 80% RH)≦18 nm, here, in Expressions (1) and (2), Rth (440 W, 30% RH) represents a retardation value in a film thickness direction at a wavelength of 440 nm measured at 25° C. and at a relative humidity of 30% and Rth (440 W, 80% RH) represents a retardation value in the film thickness direction at a wavelength of 440 nm measured at 25° C. and at a relative humidity of 80%; a polarizer and liquid crystal display device.

### CROSS-REFERENCE TO RELATED APPLICATIONS

The present application is a Continuation of PCT International Application No. PCT/JP2013/62708 filed on May 1, 2013, which claims priority under 35 U.S.C. §119 (a) to Japanese Patent Application No. 2012-109769 filed on May 11, 2012 and Japanese Patent Application No. 2013-052316 filed on Mar. 14, 2013. Each of the above applications is hereby expressly incorporated by reference, in its entirety, into the present application.

### BACKGROUND OF THE INVENTION

1. Field of the Invention

The present invention relates to an optical film capable of suppressing generation of light unevenness in a liquid crystal display device, a polarizer, and a liquid crystal display device using the optical film.

2. Description of the Related Art

Films of polymers typified by cellulose esters, polyesters, polycarbonates, cycloolefin polymers, vinyl polymers, polyimides, and the like are used in silver halide photographic light-sensitive materials, retardation films (phase difference films), polarizers, and image display devices. From these polymers, films which are excellent in flatness and uniformity can be prepared, and thus are widely employed as films in optical applications.

In a case where such a film, such as a phase difference film, a support of a phase difference film, or a polarizer protective film, is used for optical applications such as a liquid crystal display device, controlling optical anisotropy is a factor which is exceedingly important for determining performance (for example, visibility) of a display device. Improvements of compensation properties of retardation have been demanded accompanied by a request for widening of s viewing angles of liquid crystal display devices in recent years, thus, it is necessary to appropriately control a retardation value (Re; hereinafter, also simply referred to as “Re”) of an in-plane direction and a retardation value (Rth; hereinafter, also simply referred to as “Rth”) in a film thickness direction of a film arranged between a polarizing film and a liquid crystal cell. For example, among light with each respective color of R (red), G (green), and B (blue), JP-A-2007-272177 discloses an optical film having a film thickness of 80 μm, in which Re and Rth in G light having a wavelength of 550 nm, which is a center wavelength, are brought as close to zero as possible and wavelength dispersion of Re and Rth in R light having a wavelength of 650 nm and B light having a wavelength of 450 nm is controlled to be in an appropriate range, and discloses that a color change can be suppressed by matching polarizing states of each color when viewed from an inclined direction at the time when the optical film is incorporated in a liquid crystal display device to prevent light leakage.

Meanwhile, in recent years, from the viewpoint of reducing the thickness of liquid crystal display devices, there has been a demand that members be arranged by reducing the distance therebetween but it is understood that light unevenness having a circular shape or an elliptical shape is generated when a display surface is observed from the front surface or from an inclined direction under a specific condition as the reduction in thickness of liquid crystal display devices advances. There are still unclear points in regard to the mechanism of generation of light unevenness. As a reason for this, a diffusion plate on a backlight side comes into contact with a liquid crystal panel (particularly, a polarizer on the backlight side) in a high temperature and high humidity environment so that the humidity difference between the contact area and another area is generated. Due to the environment with the humidity difference, the phase difference of an optical film is changed, and accordingly, a problem in that the light unevenness having a circular shape or an elliptical shape becomes significant frequently occurs.

As described above, practically, the performance required for a polarizer protective film has been changed accompanied by the reduction in thickness of liquid crystal display devices, and accordingly, an optical film exhibiting new optical properties has been demanded.

### SUMMARY OF THE INVENTION

The present inventors have conducted examination for the purpose of providing an optical film and a polarizer capable of suppressing light unevenness having a circular shape or an elliptical shape, which is generated on a display surface, when applied to liquid crystal display devices. As a result, they found that a reduction in film thickness is effective for suppressing light unevenness having a circular shape or an elliptical shape, which is generated on the display surface, when applied to the liquid crystal display device.

However, since film rigidity is degraded when the film thickness is reduced, a new problem in which such film is elongated due to transport tension during a continuous film formation process and thermal contraction (dimensional change rate) of the optical film which has undergone a high temperature and high humidity environment is degraded, is generated. When the dimensional change rate after the optical film has undergone the high temperature and high humidity environment is great, a phase difference derived from photoelasticity of a film is generated and this leads to generation of light unevenness having a circular shape or an elliptical shape on the display surface when the film is applied to a thin liquid crystal display device.

An object of the present invention is to provide an optical film capable of suppressing generation of light unevenness having a circular shape or an elliptical shape on a display surface when the optical film is applied to a thin liquid crystal display device.

The present inventors conducted intensive examination in order to solve the above-described problems and found that light unevenness having a circular shape or an elliptical shape generated on the display surface when the optical film is applied to a liquid crystal display device can be suppressed to some extent by adjusting the film thickness to be in a range of 15 μm to 45 μm and adjusting the dimensional change rate to be ±0.3% or less.

Further, after intensive examination on the fundamental cause of suppression of the light unevenness having a circular shape or an elliptical shape on the display surface when the film thickness is reduced, the present inventors found that the light unevenness having a circular shape or an elliptical shape generated on a display device becomes difficult to visually recognize by means of light intentionally generating color unevenness in a blue color without bringing Rth of G (green) light close to zero and by bringing a phase difference of B (blue) light and R (red) light close to G (green) light as disclosed in JP-A-2007-272177.

The present inventors found that the light unevenness having a circular shape or an elliptical shape generated on the display surface can be more suppressed by decreasing the change in humidity of Rth of the optical film which has undergone the high temperature and high humidity environment. They also found that the light unevenness having a circular shape or an elliptical shape generated on the display surface can be made into the color unevenness between blue colors and then the visibility of the unevenness can be decreased by realizing an optical film whose Rth is decreased after a wet-heat treatment of B (blue) light having a wavelength of 440 nm is applied through substantial change of the technical concept of Rth compared to that of the optical film disclosed in JP-A-2007-272177 and by changing the whole color phase of the liquid crystal display device into a blue color.

As described above, it is understood that the generation of light unevenness having a circular shape or an elliptical shape generated on the display surface can be suppressed when the optical film is applied to a thin liquid crystal display device by using an optical film in which the film thickness is in a specific range and thin, Rth at a wavelength of 440 nm after a thermal treatment is in a specific range, the humidity-dependent change of Rth at a wavelength of 440 nm after a thermal treatment is small, and the thermal contraction rate before and after a thermal treatment is small.

The above-mentioned subject is solved by the present invention and the present invention has following components.

### [1] an Optical Film,

wherein a film thickness is in a range of 15 μm to 45 μm,

Rth (440 W, 30% RH) and “Rth (440 W, 30% RH)−Rth (440 W, 80% RH)” of the optical film to which a wet-heat treatment is applied at 60° C. and at a relative humidity of 90% for 48 hours satisfy the following expressions (1) and (2), and

a dimensional change rate of the film to which a treatment is applied at 60° C. and at a relative humidity of 90% for 24 hours is ±0.3% or less,

−20 nm≦Rth(440 W,30% RH)≦5 nm Expression (1)

0 nm≦Rth(440 W,30% RH)−RH(440 W,80% RH)≦18 nm, Expression (2)

(here, in Expressions (1) and (2), Rth (440 W, 30% RH) represents a retardation value in a film thickness direction at a wavelength of 440 nm measured at 25° C. and at a relative humidity of 30% and Rth (440 W, 80% RH) represents a retardation value in the film thickness direction at a wavelength of 440 nm measured at 25° C. and at a relative humidity of 80%).

[2] The optical film of [1], wherein “Rth (440 W, 30% RH)−Rth (550W, 30% RH)” of the optical film to which the wet-heat treatment is applied at 60° C. and at a relative humidity of 90% for 48 hours satisfies the following expression (3),

Rth(440 W,30% RH)−Rth(550 W,30% RH)<0 nm, Expression (3)

(in the expression (3), Rth (440 W, 30% RH) represents a retardation value in the film thickness direction at a wavelength of 440 nm measured at 25° C. and at a relative humidity of 30% and Rth (550 W, 80% RH) represents a retardation value in the film thickness direction at a wavelength of 550 nm measured at 25° C. and at a relative humidity of 80%).

[3] The optical film of [1] or [2], wherein the following expression (4) is satisfied,

−15 nm≦Rth(550 W,60% RH)≦10 nm Expression (4)

(in the expression (4), Rth (550 W, 60% RH) represents a retardation value in the film thickness direction at a wavelength of 550 nm measured at 25° C. and at a relative humidity of 60%).

[4] The optical film of any one of [1] to [3], wherein the following expression (5) is satisfied,

−28 nm≦Rth(440 W,60% RH)≦8 nm Expression (5)

(in the expression (5), Rth (440 W, 60% RH) represents a retardation value in the film thickness direction at a wavelength of 440 nm measured at 25° C. and at a relative humidity of 60%).

[5] The optical film of any one of [1] to [4], wherein the optical film contains at least cellulose acylate.
[6] The optical film of [5], wherein a degree of acyl substitution of the cellulose acylate is in a range of 2.82 to 2.95.
[7] The optical film of [5] or [6], wherein the cellulose acylate is cellulose acetate.
[8] The optical film of any one of [5] to [7], wherein a plasticizer is contained in a range of 10% by mass to 40% by mass with respect to the cellulose acylate.
[9] The optical film of [8], wherein the plasticizer contains polycondensed ester of dicarboxylic acid and diol.
[10] The optical film of [9], wherein the polycondensed ester is polycondensed ester of aliphatic dicarboxylic acid and aliphatic diol.
[11] The optical film of [10], wherein the number of carbon atoms of the aliphatic dicarboxylic acid is 3 to 8.
[12] The optical film of [10], wherein the number of carbon atoms of the aliphatic dicarboxylic acid is 4 to 6.
[13] The optical film of any one of [10] to [12], wherein the number of carbon atoms of the aliphatic diol is 2 to 6.
[14] The optical film of any one of [10] to [12], wherein the number of carbon atoms of the aliphatic diol is 2 to 4.
[15] The optical film of any one of [9] to [14], wherein a hydroxyl value of the polycondensed ester is in a range of 0 mgKOH/g to 250 mgKOH/g.
[16] The optical film of [15], wherein each of both terminals of the polycondensed ester is sealed with monocarboxylic acid.
[17] The optical film of [16], wherein the monocarboxylic acid is aliphatic monocarboxylic acid having 2 to 22 carbon atoms.
[18] The optical film of [17], wherein the number of carbon atoms of the aliphatic monocarboxylic acid is 2 or 3.
[19] The optical film of any one of [1] to [18], wherein a nitrogen-containing aromatic compound is contained.
[20] The optical film of any one of [1] to [19], wherein a polarizing element durability modifier is contained.
[21] A polarizer comprising:

a polarizing element; and

the optical film of any one of [1] to [20], which is arranged on at least one side of the polarizing element.

[22] A liquid crystal display device comprising at least one sheet of the polarizer of [21].
[23] The liquid crystal display device of [22], wherein the liquid crystal display device is an IPS liquid crystal display device, and

a liquid crystal cell satisfies the following expression (6),

250 nm≦Δnd(550)≦350 nm Expression (6)

(in Expression (6), Δnd (550) represents the product of refractive index anisotropy (Δn) and a cell gap (d) of a rod-shaped liquid crystalline molecule of a liquid crystal cell at a wavelength 550 nm).

An optical film of the present invention can suppress generation of light unevenness having a circular shape or an elliptical shape on a display surface when applied to a thin liquid crystal display device. Further, it is possible to provide a polarizer and a liquid crystal display device with high reliability using the optical film of the present invention.

According to the present invention, it is possible to provide a thin liquid crystal display device whose generation of the light unevenness having a circular shape or an elliptical shape on a display surface is suppressed and which has high reliability.

### BEST MODE FOR CARRYING OUT THE INVENTION

Hereinafter, the contents of the present invention will be described in detail. Description on constituent elements described below is made based on representative embodiments of the present invention, but the present invention is not limited to such embodiments. Further, the term “to” used before and after numerical values in the present specification is used to indicate the numerical values as the lower limit and the upper limit. Moreover, in the present specification, the term “front side” means a display surface side and “rear side” means a backlight side. Moreover, the term “front surface” in the present specification means a normal direction with respect to a display surface.

### [Optical Film]

In the optical film of the present invention (hereinafter, referred to as a film of the present invention), the film thickness is in a range of 15 μm to 45 μm, Rth (440 W, 30% RH) and “Rth (440 W, 30% RH)−Rth (440 W, 80% RH)” of the optical film to which a wet-heat treatment is applied at 60° C. and at a relative humidity of 90% for 48 hours satisfy the following expressions (1) and (2), and the dimensional change rate of the film to which a treatment is applied at 60° C. and at a relative humidity of 90% for 24 hours is ±0.3% or less.

−20 nm≦Rth(440 W,30% RH)≦5 nm Expression (1)

0 nm≦Rth(440 W,30% RH)−RH(440 W,80% RH)≦18 nm Expression (2)

(Here, in Expressions (1) and (2), Rth (440 W, 30% RH) represents a retardation value in a film thickness direction at a wavelength of 440 nm measured at 25° C. and at a relative humidity of 30% and Rth (440 W, 80% RH) represents a retardation value in the film thickness direction at a wavelength of 440 nm measured at 25° C. and at a relative humidity of 80%.)

It is possible to suppress generation of light unevenness having a circular shape or an elliptical shape on the display surface when the optical film is applied to a thin liquid crystal display device.

Hereinafter, properties, compositions, and a production method of the optical film of the present invention will be described.

### <Properties of Optical Film>

### (Film Thickness)

The optical film of the present invention has a film thickness of 15 μm to 45 μm. By adjusting the film thickness to be within such a range, Rth and the humidity dependency and the thermal contraction ratio of Rth can be easily controlled to be within the following ranges. The film thickness thereof is preferably in a range of 18 μm to 43 μm and more preferably in a range of 20 μm to 40 μm.

### (Retardation)

In the present specification, a value acquired using a structure obtained by adhering an optical film to a glass plate is used for measurement of Rth and measurement of humidity dependency of Rth of the optical film described above. An optical film processed into a sheet shape (4 cm×4 cm) is left naturally in a state in which tensile strength is not applied thereto in an environment of a temperature of 25° C. and a relative humidity of 60% for 24 hours. The optical film of the present invention is laminated on one surface of the glass plate (trade name, EAGLE, manufactured by Corning, Inc.) through a thickener (trade name, SK-2057, manufactured by Soken Chemical Co., Ltd.) in an environment of a temperature of 25° C. and a relative humidity of 60%.

In a case where the optical film of the present invention is used as a polarizer protective film, the birefringence (Re, Rth) is changed due to stress caused by contraction of a substrate or a polarizing element of a liquid crystal cell after a thermal treatment in some cases. The photoelastic change caused by the difference of the thermal contraction rates between glass and the polarizing element as well as the change of refractive index anisotropy Δn due to the thermal treatment can be reflected by performing measurement using the above-described structure. Accordingly, the change of humidity dependency of Rth and Rth in the same state in which the optical film of the present invention is adhered to the glass substrate of the liquid crystal cell of the liquid crystal display device to be subjected to the thermal treatment is controlled, and thus the light unevenness having a circular shape or an elliptical shape generated on the display surface when the optical film is applied to the liquid crystal display device can be reliably improved by performing measurement using the above-described structure.

The structure obtained by adhering the optical film of the present invention to the glass plate is left in an environment of a temperature of 60° C. and a relative humidity of 90% for 48 hours (hereinafter, this treatment is referred to as a wet-heat treatment). The structure after the wet-heat treatment is left naturally in an environment of a temperature of 25° C. and a relative humidity of 30% for 120 minutes, and then a value of Rth having a wavelength of 440 nm is measured in the same environment. The retardation value in the film thickness direction at this time is defined as Rth (440 W, 30 RH %).

The structure after the measurement is left naturally in an environment of a temperature of 25° C. and a relative humidity of 80% for 120 minutes, and then a value of Rth having a wavelength of 440 nm is measured in the same environment. The retardation value in the film thickness direction at this time is defined as Rth (440 W, 80 RH %).

Rth (440 W, 30 RH %) and Rth (440 W, 80 RH %) of the optical film of the present invention satisfy the following expressions (1) and (2). Further, the value of “Rth (440 W, 30% RH)−Rth (440 W, 80% RH)” is defined as humidity dependency of Rth.

−20 nm≦Rth(440 W,30% RH)≦5 nm Expression (1)

0 nm≦Rth(440 W,30% RH)−RH(440 W,80% RH)≦18 nm Expression (2)

(In Expressions (1) and (2), Rth (440 W, 30% RH) represents a retardation value in the film thickness direction at a wavelength of 440 nm measured at 25° C. and at a relative humidity of 30% and Rth (440 W, 80% RH) represents a retardation value in the film thickness direction at a wavelength of 440 nm measured at 25° C. and at a relative humidity of 80%.)

Rth (440 W, 30% RH) is in a range of −20 nm to 5 nm, preferably in a range of −18 nm to 4 nm, and more preferably in a range of −15 nm to 3 nm. It is possible to reduce the visibility of color unevenness having a circular shape or an elliptical shape to be visually recognized when the display surface at the time when the optical film of the present invention is incorporated in the thin liquid crystal display device is observed from the inclined direction after the thermal treatment by controlling the Rth of a film having a wavelength of 440 nm after the wet-heat treatment, and therefore, light unevenness can be improved.

The humidity dependency of Rth represented by “Rth (440 W, 30% RH)−Rth (440 W, 80% RH)” described above is in a range of 0 nm to 18 nm, preferably in a range of 0 nm to 15 nm, and more preferably in a range of 0 nm to 13 nm. By decreasing the change in Rth in a case where the humidity of the film after the thermal treatment is changed, it is possible to provide a liquid crystal display device with high reliability and to improve light unevenness having a circular shape or an elliptical shape visually recognized when the liquid crystal display device is observed from the inclined direction of the display surface.

In the optical film of the present invention, it is preferable that Rth (440 W, 30% RH)−Rth (550 W, 30% RH) of the optical film to which the wet-heat treatment is applied at 60° C. and at a relative humidity of 90% for 48 hours satisfy the following Expression (3) from the viewpoint of a black color appearing when the liquid crystal display device is observed from the inclined direction. In addition, the method of measuring “Rth (440 W, 30% RH)−Rth (550 W, 30% RH)” is the same as the measurement method used when Rth of the optical film described above and the humidity dependency are measured.

Rth(440 W,30% RH)−Rth(550 W,30% RH)<0 nm, Expression (3)

(In the expression (3), Rth (440 W, 30% RH) represents a retardation value in the film thickness direction at a wavelength of 440 nm measured at 25° C. and at a relative humidity of 30% and Rth (550 W, 80% RH) represents a retardation value in the film thickness direction at a wavelength of 550 nm measured at 25° C. and at a relative humidity of 800).

It is preferable that the optical film of the present invention satisfy the following Expression (4) in the initial state from the viewpoint of the contrast when the liquid crystal display device is observed from the inclined direction.

−15 nm≦Rth(550 W,60% RH)≦10 nm Expression (4)

(In Expression (4), Rth (550 W, 60% RH) represents a retardation value in the film thickness direction at a wavelength of 550 nm measured at 25° C. and at a relative humidity of 60%).

Rth (550 W, 60% RH) is more preferably in a range of −13 nm to 8 nm, particularly preferably in a range of −10 nm to 5 nm, and most preferably in a range of −8 nm to 0 nm.

It is preferable that the optical film of the present invention satisfy the following Expression (5) in the initial state from the viewpoint of decreasing the light unevenness having a circular shape or an elliptical shape to be visually recognized when the display surface at the time when the optical film of the present invention is incorporated in the liquid crystal display device is observed from the front surface before the thermal treatment (initial state).

−28 nm≦Rth(440 W,60% RH)≦8 nm Expression (5)

(In Expression (5), Rth (440 W, 60% RH) represents a retardation value in the film thickness direction at a wavelength of 440 nm measured at 25° C. and at a relative humidity of 60%).

Rth (440 W, 60% RH) is more preferably in a range of −26 nm to 6 nm and particularly preferably −23 nm to 3 nm.

Where, Re and Rth in each measuring wavelength are defined as the following Equations (I) and (II).

Re=(nx−ny)×d (nm) Equation (I)

Rth={(nx+ny)/2−nz}×d (nm) Equation (II)

(where nx is a refractive index in a slow axis direction in the plane of the film, ny is a refractive index in a fast axis direction in the plane of the film, nz is a refractive index in a thickness direction of the film, and d is a thickness of the film (nm).)

In the present specification, Re and Rth (unit: nm) are obtained according to the following method.

First, a film is humidity controlled at 25° C. and relative humidity 60% for 24 hours, and then the average refractive index (n) represented by the following Equation (III) is obtained by using a prism coupler (MODEL2010 Prism Coupler: manufactured by Metricon) and using a solid state laser of 532 nm at 25° C. and relative humidity 60%.

n=(n_{TE}×2+n_{TM})/3 Equation (III):

[where n_{TE} is a refractive index measured using light polarized in the plane direction of the film, and n_{TM} is a refractive index measured using light polarized in the normal direction of the film surface.]

Next, Re is measured by irradiating with an incident light having a specific wavelength in the normal direction of the film using KOBRA 21ADH or WR (manufactured by Oji Scientific Instruments Co., Ltd.).

When a film to be measured is represented by a uniaxial or biaxial refractive index ellipsoid, Rth is calculated by the following method.

A total of six points of Re are measured by irradiating with an incident light having a wavelength of λ nm from each of the inclined directions at an angle increasing in 10° step increments up to 50° in one direction from the normal direction of the film by taking the in-plane slow axis (decided by KOBRA 21ADH or WR) as an inclined axis (axis of rotation) (when there is no slow axis, any in-plane direction of the film will be taken as an axis of rotation), and then Rth is calculated by KOBRA 21ADH or WR based on the retardation value measured, the average refractive index, and the film thickness value inputted.

In the case of a film having a direction in which a retardation value is zero at a certain tilt angle from the normal direction about the in-plane slow axis as an axis of rotation, a retardation value at a tilt angle greater than that certain tilt angle is changed into a minus sign, and then is calculated by KOBRA 21ADH or WR.

Rth may also be calculated based on two retardation values measured in two different directions at any angle by taking the slow axis as an inclined axis (when there is no slow axis, any in-plane direction of the film will be taken as an axis of rotation), the average refractive index, and the film thickness inputted and from the following Equations (IV) and (V).

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad Equations ( IV )$$

[where Re (θ) represents a retardation value in a direction inclined by an angle (θ) from the normal direction. nx represents a refractive index in an in-plane slow axis direction, ny represents a refractive index in an in-plane direction perpendicular to nx, nz represents a refractive index in a thickness direction perpendicular to nx and ny, and d is a film thickness.]

Rth=((nx+ny)/2−nz)xd Equation (V):

When a film to be measured is not represented by a uniaxial or biaxial refractive index ellipsoid, so-called, when the film has no optic axis, Rth is calculated in the following manner.

Eleven points of Re are measured by irradiating with an incident light having a wavelength of λ nm from each of the inclined directions at an angle increasing in 10° step increments from −50° to +50° in one direction from the normal direction of the film by taking the in-plane slow axis (decided by KOBRA 21ADH or WR) as an inclined axis (axis of rotation), and then Rth is calculated by KOBRA 21ADH or WR based on the retardation value measured, the average refractive index, and the film thickness value inputted. nx, ny, and nz are calculated by inputting these average refractive index values and the film thickness into KOBRA 21ADH or WR. Nz=(nx−nz)/(nx−ny) is further calculated from the thus calculated nx, ny, and nz.

In the above measurements, values described in a polymer handbook (John Wiley & Sons, Inc.) and catalogues of various optical films may be used as the average refractive index. For films whose average refractive index is unknown, the value may be measured by using the above-described method. Values of average refractive indices of main optical films are illustrated below: Cellulose acylate (1.48), cycloolefin polymer (1.52), polycarbonate (1.59), polymethyl methacrylate (1.49) and polystyrene (1.59).

### (Dimensional Change Rate)

In the optical film of the present invention, the dimensional change rate of the film which is treated at 60° C. and at a relative humidity of 90% for 24 hours is ±0.3% or less.

When the dimensional change rate is within the above-described range, light leakage when the optical film is incorporated in the liquid crystal display device can be suppressed. The dimensional change is more preferably in a range of −0.2% to 2% and particularly preferably in a range of −0.1% to 0.1%.

Further, it is preferable that the dimensional change of the optical film of the present invention be within the above-described range in a direction in which the sound speed becomes the maximum and in a direction orthogonal to the direction in which the sound speed becomes the maximum, respectively.

In the present invention, the direction in which the sound wave propagation speed (hereinafter, also simply referred to as “sound speed”) of the optical film becomes the maximum is acquired as a direction in which the propagation speed of longitudinal wave vibration of the ultrasonic pulse becomes the maximum using an orientation measuring machine (SST-2500, manufactured by Nomura Shoji Co., Ltd.) after the humidity of the film is adjusted at 25° C. and at a relative humidity of 60% for 24 hours.

### <Composition of Optical Film>

Material of Optical Film

As a material for forming the optical film of the invention, a polymer excellent in optical performance transparency, mechanical strength, thermal stability, moisture blocking property, isotropy or the like can be used.

For instance, a polycarbonate film, a polyester polymer, for example, polyethylene terephthalate or polyethylene naphthalate, an acrylic polymer, for example, polymethyl methacrylate, and a styrene polymer, for example, polystyrene or an acrylonitrile-styrene copolymer (AS resin) are exemplified.

Also, polyolefin, for example, polyethylene or polypropylene, a polyolefin polymer, for example, an ethylene-propylene copolymer, a vinyl chloride polymer, an amide polymer, for example, nylon or an aromatic polyamide, an imide polymer, a sulfone polymer, a polyethersulfone polymer, a polyetheretherketone polymer, a polyphenylene sulfide polymer, a vinylidene chloride polymer, a vinyl alcohol polymer, a vinyl butyral polymer, an arylate polymer, a polyoxymethylene polymer, an epoxy polymer, and a mixture of the polymers described above are exemplified.

Further, the optical film of the invention may also be formed as a cured layer of an ultraviolet curing or thermal curing resin of an acrylic type, urethane type, acrylurethane type, epoxy type, silicone type or the like.

Moreover, as the material for forming the optical film of the invention, a thermoplastic norbornene resin can be preferably used.

As the thermoplastic norbornene resin, ZEONEX and ZEONOR produced by Zeon Corp. and ARTON produced by JSR Corp. are exemplified.

Furthermore, as the material for forming the optical film of the invention, a cellulose polymer (hereinafter refers to as cellulose acylate) which has been conventionally used as a transparent protective film of a polarizer and is typified by triacetyl cellulose can be preferably used.

The content of the polymer as the material for forming the optical film of the invention in the optical film is 50% by mass or more.

In these polymers as the material for forming the optical film of the invention, a cellulose acylate is preferred.

A cellulose acylate is mainly described in detail below.

### (Cellulose Acylate)

Next, a cellulose acylate in the present invention will be described.

A cellulose acylate used in the optical ester film of the invention is preferably an ester of cellulose and a carboxylic acid having about 2 to 22 carbon atoms (so-called cellulose acylate), and more preferably a lower carboxylic acid ester having 6 or less carbon atoms.

Examples of the cellulose as a cellulose acylate raw material used in the invention include cotton linter, wood pulp (broad leaf pulp, and needle leaf pulp) and the like, and a cellulose acylate obtained from any raw material cellulose can be used.

In some cases, a mixture thereof may be also used. Detailed descriptions on these raw material celluloses may be found in, for example, Lecture on Plastic Materials (17) Cellulose Resins (Maruzawa and Uda, THE NIKKAN KOGYO SHIMBUN, LTD., published in 1970) or Japan Institute of Invention and Innovation Journal of Technical Disclosure 2001-1745 (pp. 7 to 8).

In the cellulose acylate preferably used in the present invention, although the degree of substitution of acetic acid and/or an aliphatic acid having 3 to 22 carbon atoms with a hydroxyl group of cellulose is not particularly limited, when the film is used as a polarizer and a liquid crystal display device, the degree of substitution of acyl with a hydroxyl group of cellulose is preferably 2.00 to 3.00, more preferably 2.82 to 2.95, particularly preferably 2.82 to 2.93, and more particularly preferably 2.84 to 2.90 in order to impart moisture permeation or absorption which is appropriate for the film.

Examples of methods for measuring the degree of substitution of acetic acid and/or an aliphatic acid having 3 to 22 carbon atoms with a hydroxyl group of cellulose include a method using ¹³C-NMR analysis in accordance with the methods described in Tezuka et al., Carbohydr. Res., 273 (1995), pp. 83 to 91.

Among acetic acid and/or an aliphatic acid having 3 to 22 carbon atoms substituted with a hydroxyl group of cellulose, the acyl group having 2 to 22 carbon atoms may be, but not particularly limited to, aliphatic or aromatic, and may be used either alone or in mixtures of two or more kinds thereof. Examples of the cellulose ester having an acyl group include alkylcarbonyl ester, alkenylcarbonyl ester, or aromatic carbonyl ester, aromatic alkyl carbonyl ester and the like of cellulose, each of which may have a group further substituted. Examples of preferred acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, cinnamoyl and the like. Among them, acetyl, propionyl, butanoyl, dodecanoyl, octadecanoyl, t-butanoyl, oleoyl, benzoyl, naphthylcarbonyl, cinnamoyl, and the like are preferred and acetyl, propionyl, and butanoyl are more preferred.

Among them, from the viewpoint of ease of synthesis, costs, ease of substituent distribution control and the like, an acetyl group alone (cellulose acetate), or a combination of an acetyl group and a propionyl group (cellulose acetate propionate) is preferred, and an acetyl group alone (cellulose acetate) is particularly preferred.

The polymerization degree of cellulose acylate preferably used in the present invention is 180 to 700 as the viscosity average polymerization degree, and the polymerization degree of cellulose acetate is more preferably 180 to 550, even more preferably 180 to 400, and particularly preferably 180 to 350, as the viscosity average polymerization degree. To control the polymerization degree in above range is preferable from the viewpoint of film manufacturing and film strength. An average polymerization degree may be measured by the extreme viscosity method of Uda et al. (Kazuo Uda and Hideo Saito, Bulletin of The Society of Fiber Science and Technology, Japan, vol. 18, No. 1, pp. 105-120 (1962)). The method is described in detail in Japanese Patent Application Laid-Open No. Hei 9-95538.

The molecular weight distribution of the cellulose acylate preferably used in the present invention is evaluated by gel permeation chromatography, and it is preferred that the polydispersity index Mw/Mn (Mw is a mass average molecular weight and Mn is a number average molecular weight) is small, while the molecular weight distribution is narrow. Specific values of Mw/Mn are preferably 1.0 to 4.0, more preferably 2.0 to 3.5, and most preferably 2.3 to 3.4.

Removal of low-molecular components results in an increase in average molecular weight (polymerization degree) but makes the viscosity become lower than that of a typically used cellulose acylate, which is useful. A cellulose acylate having a small amount of low-molecular components may be obtained by removing low-molecular components from cellulose acylate synthesized by a typical method. The removal of the low-molecular components may be performed by washing the cellulose acylate with an appropriate organic solvent. When a cellulose acylate having a small amount of low-molecular components is prepared, an amount of a sulfuric acid catalyst in the acetification reaction is preferably adjusted to 0.5 to 25 parts by mass, based on 100 parts by mass of cellulose. The amount of a sulfuric acid catalyst within the above-mentioned range makes it possible to synthesize cellulose acylate that is preferable in terms of the molecular weight distribution (with narrow molecular weight distribution). When the cellulose acylate is used for preparing a cellulose acylate film of the present invention, the cellulose acylate preferably has a water content of 2% by mass or less, more preferably 1% by mass or less, and particularly preferably 0.7% by weight or less. In general, it is known that the cellulose acylate contains water and a water content thereof is 2.5 to 5% by mass. In order to attain the aforementioned water content of the cellulose acylate in the present invention, drying is required, and the method thereof is not particularly limited as long as a desired water content may be attained. For the cellulose acylate of the present invention, a raw material cotton or a synthesizing method thereof are described in detail in Japan Institute of Invention and Innovation Journal of Technical Disclosure (Technical Publication No. 2001-1745, Mar. 15, 2001, published by Japan Institute of Invention and Innovation) pp. 7 to 12.

From the viewpoint of substituent, degree of substitution, polymerization degree, molecular weight distribution and the like, a single kind or two or more different kinds of cellulose acylate may be combined for use in the invention.

### (Plasticizer)

Plasticizer used in the optical film of the present invention will be described.

In the present invention, the plasticizer preferably includes a polycondensed ester of a dicarboxylic acid and a diol.

The polycondensed ester may be obtained by a known method such as a dehydrative condensation reaction of polyvalent basic acid and polyvalent alcohol, addition and dehydrative condensation reaction of polyvalent alcohol and anhydrous dibasic acid and, and the like, and thus, the polyester is one of oligomers of a polycondensed ester preferably formed from dibasic acid and diol and a derivative thereof (in the present specification, referred to as “polycondensed ester”).

The structure, molecular weight, and added amount of polycondensed ester may be selected such that the polycondensed ester is compatible with a dope of the polymer (preferably a cellulose acylate) as the material for forming the optical film of the invention and the optical film satisfies desired optical properties and other performances.

In the optical film of the present invention, plasticizer is contained in an amount of preferably 10% to 40% by mass, more preferably 10% to 30% by mass, even more preferably 10% to 25% by mass, based on the polymer (preferably a cellulose acylate) as the material for forming the optical film of the invention. The content is preferably 10% by mass or more since the light unevenness having a circular shape or an elliptical shape in a display surface where the optical film of the invention is applied to the thin type liquid crystal display device can be reduced, and the content is preferably 40% by mass or less from the viewpoint of improving a roll quality of the film. When two or more kinds of polyesters are included, the total content of the corresponding two or more kinds of polyesters may be within the above ranges.

A number average molecular weight (Mn) of the polycondensed ester in the present invention may be obtained from gel permeation chromatography (GPC).

In the present invention, the number average molecular weight of polycondensed ester is preferably 2,500 or less, more preferably 400 to 2,500, particularly preferably 500 to 2300, and most preferably 600 to 1800. The change in humidity of Rth can be prevented by using a polycondensed ester having a number average molecular weight of 2,500 or less, and thus, light unevenness can be reduced. When the content is 400 or more, the volatilization of polycondensed ester in the preparation process may be inhibited in combination with the following technology which removes low-molecular weights.

In the polycondensed ester in the present invention, a ratio (fraction by weight) of components having a molecular weight of 500 or less is preferably less than 8% and more preferably less than 7%. The ratio of components having a molecular weight of 500 or less may be obtained from gel permeation chromatography (GPC).

When the optical film is formed, volatilizing polyester components are low-molecular weight components, and as described above, the use of the polycondensed ester with an inhibited ratio of low-molecular weight components having a molecular weight of 500 or less can significantly reduce the contamination of the preparation process. After the film is formed, the bleed out of polycondensed ester from the optical film is also prevented, and in particular, the effect obtained by adding polycondensed ester (for example, reduction of humidity dependence of Rth) may be effectively exhibited using a much lower adding amount.

In order to set the ratio of low-molecular weight components to less than 8%, methods by distillation such as typical vacuum distillation, thin film (molecular) distillation, and the like, or chromatography may be exemplified, but a thin film distillation, by which low-molecular weight components may be removed in a short time, is preferred.

A dicarboxylic acid may be preferably exemplified as a dibasic acid constituting the corresponding polycondensed ester.

Examples of the dicarboxylic acid include an aliphatic dicarboxylic acid, an aromatic and the like, and thus any of the dicarboxylic acid may be used, and in particular, an aliphatic dicarboxylic acid may be preferably used.

Among the aliphatic dicarboxylic acids, an aliphatic dicarboxylic acid having 3 to 8 carbon atoms is preferable, and in particular, an aliphatic dicarboxylic acid having 4 to 6 carbon atoms is more preferable. The aliphatic dicarboxylic acid having lower carbon atoms may reduce the moisture vapor permeability of an optical film, and is also appropriate even in terms of compatibility with the polymer (preferably a cellulose acylate).

Specific compounds of the aliphatic dicarboxylic acid include succinic acid, maleic acid, adipic acid, glutaric acid and the like, and they may be used either alone or in combination of two or more thereof. Succinic acid, adipic acid, or mixtures thereof are preferable, and adipic acid is more preferable.

A diol constituting the polycondensed ester is exemplified by an aliphatic diol, an aromatic diol, and the like, and an aliphatic diol is particularly preferable.

Among the aliphatic diols, an aliphatic diol having 2 to 6 carbon atoms is preferable, and an aliphatic diol having 2 to 4 carbon atoms is more preferable. This is due to the fact that an aliphatic diol having lower carbon atoms has excellent compatibility with the dope of the polymer (preferably a cellulose acylate) as the material for forming the optical film of the invention or the optical film (preferably a cellulose acylate film), and excellent bleed-out (drawing out) resistance to high temperature and high humidity treatment.

Examples of the aliphatic diol include ethylene glycol, diethylene glycol, 1,2-propylene glycol, 1,3-propylene glycol, butylenes glycol, and the like, and they may be used either alone or in combination of two or more thereof. Preferably, the diols are ethylene glycol, 1,2-propylene glycol, and 1,3-propylene.

The polycondensed ester in the present invention is preferably a polycondensed ester of an aliphatic dicarboxylic acid and an aliphatic diol particularly in terms of effects of the present invention.

Both terminals of the polycondensed ester in the present invention are preferably blocked with reacting with a monocarboyxlic acid. As the example of the monocarboyxlic acid used in blocking, an aliphatic monocarboxylic acid such as acetic acid, propionic acid, butanoic acid, caprylic acid, caproic acid, decanoic acid, dodecanoic acid, stearic acid, oleic acid and the like, and an aromatic monocarboxylic acids such as benzoic acid, p-tert-butylbenzoic acid, o-toluic acid, m-toluic acid, p-toluoylic acid, dimethylbenzoic acid, ethylbenzoic acid, n-propylbenzoic acid, aminobenzoic acid, acetoxybenzoic acid and the like. These monocarboxylic acids may be used either alone or in mixtures of two or more thereof.

As the monocarboyxlic acid used in blocking, an aliphatic monocarboxylic acid is preferable. The monocarboxylic acids are more preferably an aliphatic monocarboxylic acid having 2 to 22 carbon atoms, even more preferably an aliphatic monocarboxylic acid having 2 to 3 carbon atoms, and particularly preferably an aliphatic monocarboxylic acid residue having 2 carbon atoms. For example, acetic acid, propionic acid, butanoic acid, benzoic acid, and derivatives thereof are preferred, acetic acid or propionic acid is more preferred, and acetic acid (with the terminals being an acetyl group) is particularly preferred. When the monocarboxylic acid residue on both terminals thereof has 3 carbon atoms or less, the condensate has reduced volatility, and thus the loss of the condensate of the polyhydric alcohol and the polybasic acid on heating may not be increased, thereby preventing the occurrence of process contamination or reducing the occurrence of surface defects.

In the optical film of the present invention, the hydroxyl value of the polycondensed ester is preferably in a range of 0 mgKOH/g to 250 mgKOH/g, more preferably in a range of 0 mgKOH/g to 230 mgKOH/g, particularly preferably in a range of 0 mgKOH/g to 200 mgKOH/g, and more particularly preferably in a range of 0 mgKOH/g to 100 mgKOH/g. Further, an acetic anhydride method described in Japanese Industrial Standards JIS K 1557-1:2007 can be applied to the measurement of the hydroxyl value of the polycondensed ester and the acetic anhydride method described in Japanese Industrial Standards JIS K 1557-1:2007 is used.

In the present invention, a plasticizer other than the polycondensed ester may be used as a plasticizer. In this case, in the present invention, it is preferable to use only the polycondensed ester as a plasticizer without using other plasticizers.

Examples of other plasticizers include a phosphoric acid ester-based plasticizer, a phthalic acid ester-based plasticizer, a trimellitic acid ester-based plasticizer, a pyromellitic acid ester-based plasticizer, a polyvalent alcohol-based plasticizer, a glycolate-based plasticizer, and a citric acid ester-based plasticizer. Examples of the phosphoric acid ester-based plasticizer include triphenyl phosphate (TPP), tricresyl phosphate (TCP), cresyl diphenyl phosphate, octyl diphenyl phosphate, biphenyl diphenyl phosphate (BDP), trioctyl phosphate, and tributyl phosphate; and examples of the carboxylic acid ester-based plasticizer include dimethyl phthalate (DMP), diethyl phthalate (DEP), dibutyl phthalate (DBP), dioctyl phthalate (DOP), diphenyl phthalate (DPP), diethylhexyl phthalate (DEHP), O-acetyl triethyl citrate (OACTE), O-acetyl tributyl citrate (OACTB), acetyl triethyl citrate, acetyl tributyl citrate, butyl oleate, methyl acetyl ricinoleate, dibutyl cebacate, triacetine, tributyrin, butyl phthalyl butyl gylcolate, ethyl phthalyl ethyl glycolate, methyl phthalyl ethyl glycolate, and butyl phthalyl butyl glycolate. Further, these may be used in combination of two or more kinds thereof.

The preferable range of the addition amount of another plasticizer is the same as the preferable range of the addition amount of the polycondensed ester. The preferable range of the molecular weight of another plasticizer is the same as the preferable range of the molecular weight (number average molecular weight) of the polycondensed ester.

### (Nitrogen-Containing Aromatic Compound)

It is preferred that the optical film of the present invention includes at least one nitrogen-containing aromatic compound.

It is preferred that the nitrogen-containing aromatic compound functions as a retardation controlling agent. The optical anisotropy of the optical film of the present invention is controlled by the addition of the aforementioned polycondensed ester, and the above nitrogen-containing aromatic compound may be further added according to a desired retardation.

It is preferred that the nitrogen-containing aromatic compound is a compound having at least two aromatic rings. It is preferable to exhibit the optically positive uniaxiality when a compound having at least two aromatic rings is uniformly oriented.

The molecular weight of the nitrogen-containing aromatic compound is preferably 300 to 1,200 and more preferably 400 to 1,000.

The content of the nitrogen-containing aromatic compound in the optical film of the present invention is preferably 0.1% to 6.0% by mass, more preferably 0.5% to 5.0% by mass, and particularly preferably 1.0% to 4.5% by mass based on the polymer (preferably a cellulose acylate) as the material for forming the optical film of the invention.

As the nitrogen-containing aromatic compound, those described in paragraphs [0026] to [0115] of WO2011/040468 may be preferably used.

### (Polarizing Element Durability Modifier)

The polarizing element durability modifier may be added to the optical film and a phenol-based compound having a specific structure, which has an alkyl group with which an aromatic ring is substituted as a substituent, can be preferably used as the polarizing element durability modifier.

It is considered that decrease in cross transmittance can be suppressed by suppressing diffusion of boron derived from boric acid in the polarizing element and maintaining polyiodine ions in a large amount through addition of a phenol-based compound having a specific structure, which has an alkyl group with which an aromatic ring is substituted as a substituent.

It is preferable that the polarizing element durability modifier be selected from a compound represented by the following general formula (1), a polymer having a repeating unit derived from a monomer represented by the general formula (2), a compound represented by the general formula (3), and a compound represented by the general formula (III).

### <<Compound Represented by General Formula (1)>>

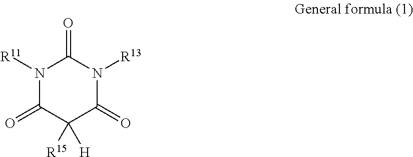

(In general formula (1), R¹¹, R¹³ and R¹⁵ each independently represents a hydrogen atom, an alkyl group having from 1 to 20 carbon atoms, an cycloalkyl group having from 3 to 20 carbon atoms, an alkenyl group having from 2 to 20 carbon atoms or an aryl group having from 6 to 20 carbon atoms.)

In general formula (1), R¹⁵ is preferably an alkyl group having from 1 to 20 carbon atoms, a cycloalkyl group having from 3 to 20 carbon atoms or an aryl group having from 6 to 20 carbon atoms, more preferably an alkyl group having from 1 to 12 carbon atoms, a cycloalkyl group having from 3 to 12 carbon atoms or an aryl group having from 6 to 18 carbon atoms, particularly preferably an alkyl group having from 1 to 6 carbon atoms, a cycloalkyl group having from 3 to 6 carbon atoms or an aryl group having from 6 to 12 carbon atoms, more particularly preferably a methyl group, an ethyl group, an isopropyl group, a cyclohexyl group or a phenyl group, most preferably a methyl group, isopropyl group or a phenyl group.

In general formula (1), R¹¹ and R¹³ are each independently preferably a hydrogen atom, an alkyl group having from 1 to 20 carbon atoms, a cycloalkyl group having from 3 to 20 carbon atoms or an aryl group having from 6 to 20 carbon atoms, more preferably a hydrogen atom, an alkyl group having from 1 to 12 carbon atoms, a cycloalkyl group having from 3 to 12 carbon atoms or an aryl group having from 6 to 12 carbon atoms, particularly preferably a hydrogen atom, an alkyl group having from 1 to 6 carbon atoms, a cycloalkyl group having from 3 to 6 carbon atoms or an phenyl group, more particularly preferably a hydrogen atom, a methyl group, an ethyl group, a cyclohexyl group or a phenyl group, most preferably a methyl group or a phenyl group.

In general formula (1), it is preferable that R¹¹ is an alkyl group having from 1 to 20 carbon atoms, a cycloalkyl group having from 3 to 20 carbon atoms or an aryl group having from 6 to 20 carbon atoms and that R¹³ is a hydrogen atom or an aryl group having from 6 to 20 carbon atoms. It is more preferable that R¹¹ is an alkyl group having from 1 to 12 carbon atoms, a cycloalkyl group having from 3 to 12 carbon atoms or an aryl group having from 6 to 12 carbon atoms and that R¹³ is a hydrogen atom or an aryl group having from 6 to 12 carbon atoms. It is particularly preferable that R¹¹ is an alkyl group having from 1 to 3 carbon atoms or a cycloalkyl group and that R¹³ is a hydrogen atom or a phenyl group. It is more particularly preferable that R¹¹ is a methyl group and that R¹³ is a hydrogen atom or a phenyl group.

R¹⁵ may further have a substituent. The substituent which R¹⁵ may have is not particularly restricted as long as it is not contrary to the spirit of the invention, and is preferably a halogen atom, an alkyl group or an aryl group, more preferably a halogen atom, an alkyl group having from 1 to 6 carbon atoms or an aryl group having from 6 to 12 carbon atoms, and particularly preferably a chlorine atom, a methyl group or a phenyl group. In particular, where R¹⁵ is an alkyl group having from 1 to 20 carbon atoms, R¹⁵ preferably has an aryl group as a substituent, more preferably has an aryl group having from 6 to 12 carbon atoms as a substituent, particularly preferably has a phenyl group as a substituent. Where R¹⁵ is an aryl group having from 6 to 20 carbon atoms, R¹⁵ preferably has a hydrogen atom or an alkyl group having from 1 to 20 carbon atoms as a substituent, more preferably has a hydrogen atom or an alkyl group having from 1 to 6 carbon atoms as a substituent, particularly preferably has an chlorine atom or a methyl group as a substituent.

R¹¹ and R¹³ may further have a substituent. The substituent which R¹¹ and R¹³ may have is not particularly restricted as long as it is not contrary to the spirit of the invention, and is preferably an aryl group having from 6 to 12 carbon atoms, and more preferably a phenyl group.

Specific examples of the compound represented by the general formula (1) are set forth below, but the invention should not be construed as being limited thereto.

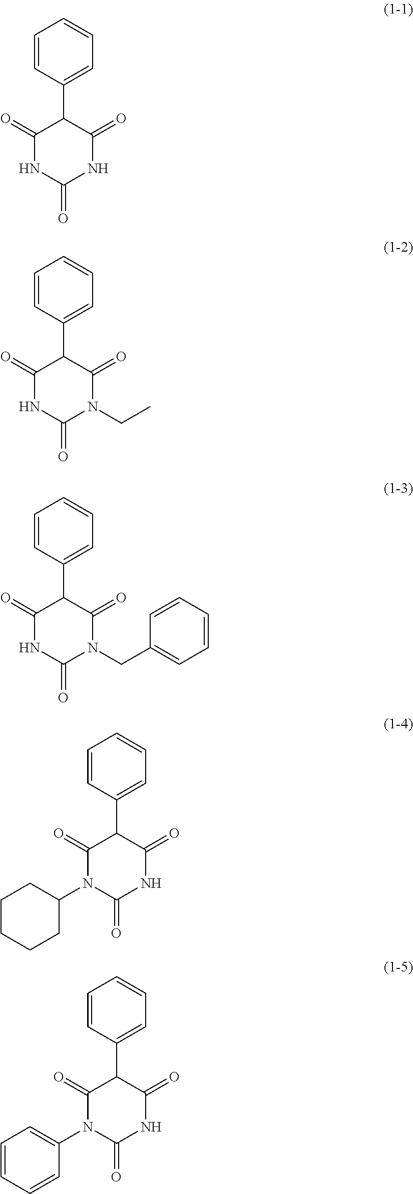

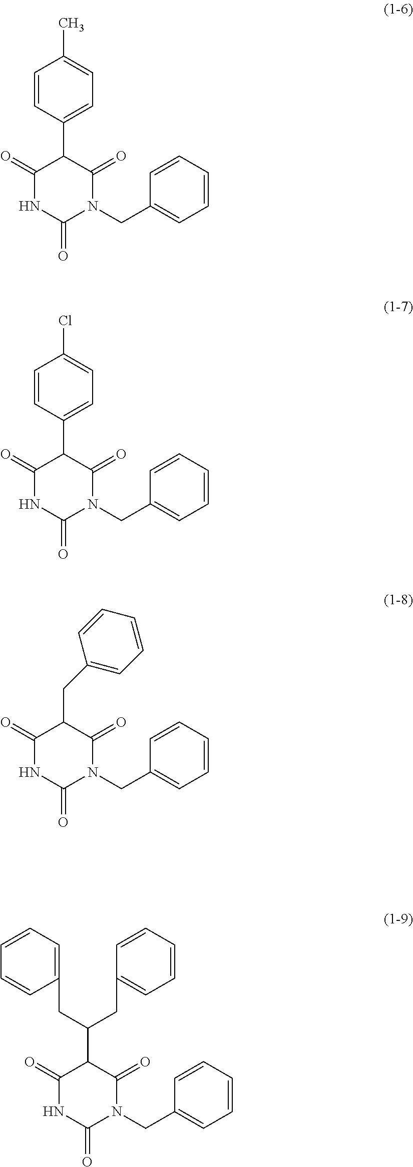

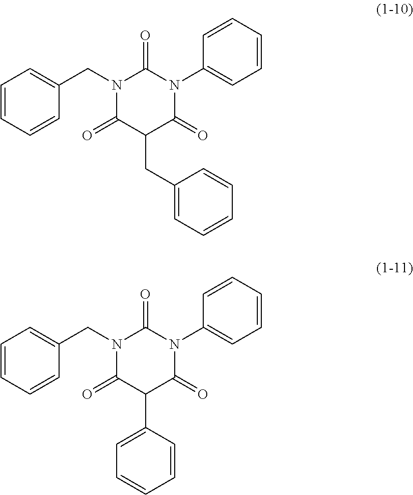

The compound represented by the general formula (1) may be from commercially available compounds or may be synthesized by a known method.

In a case where the optical film of the present invention contains the compound represented by the general formula (1), the polarizing element durability improvement effect is small when the addition amount of the compound represented by the general formula (1) is extremely small and bleed out may occur when the addition amount thereof is extremely large. Therefore, the addition amount of the compound is preferably in a range of 1 part by mass to 20 parts by mass, more preferably in a range of 1 part by mass to 10 parts by mass, still more preferably in a range of 2 parts by mass to 7 parts by mass, and particularly preferably in a range of 3 parts by mass to 6 parts by mass with respect to 100 parts by mass of the polymer (preferably, cellulose acylate) which is a material forming the optical film of the present invention.

<<Polymer Containing a Repeating Unit Derived from a Monomer Represented by General Formula (2)>>

At first, a polymer containing a repeating unit derived from a monomer represented by general formula (2) is described in detail.

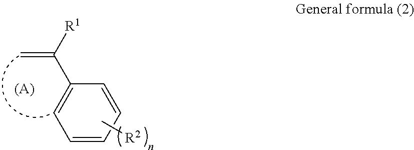

(In general formula (2), R¹ represents a hydrogen atom or an aliphatic group having 1 to 4 carbon atoms. R² represents a substituent group. (A) represents an atomic group necessary to form a 5- or 6-membered ring. n represents an integer of 0 to 4.)

R¹

In general formula (2), R¹ represents a hydrogen atom or an aliphatic group having 1 to 4 carbon atoms. R¹ is not particularly limited, but preferably a hydrogen atom, a methyl group, or an ethyl group.

R²

R² represents a substituent group, and, as the substituent group, an aliphatic group or an aromatic group is preferred.

R² is not particularly limited. However, as the aliphatic group, an alkyl group, an alkenyl group, an alkynyl group, and a cycloalkyl group are preferable. An alkyl group having 1 to 6 carbon atoms is more preferable. A methyl group, an ethyl group, a propyl group, and a butyl group are still more preferable. A methyl group and a t-butyl group are particularly preferable. As the aromatic group, a phenyl group, a naphthyl group, and a biphenyl group are preferable. A phenyl group is particularly preferable.

n

n represents an integer of 0 to 4, preferably from 0 to 2, and more preferably from 0 to 1. When n is 0, it means that the substituent R2 does not exist. However, in this case, it means that a hydrogen atom exists in the chemical formula. Also in the other chemical formulae in the present specification, the chemical structures are commensurately construed in the same manner as the above.

(A)

(A) represents an atomic group necessary to form a 5- or 6-membered ring, and preferably an atomic group necessary to form a 5- or 6-membered aromatic ring. In the present specification, the aromatic ring is in accordance with concept including a hetero-atom-free aromatic ring and a hetero-atom-containing saturated or unsaturated hetero ring.

In the present invention, the repeating unit derived from the monomer represented by general formula (2) is preferably represented by the following general formula (2-1), general formula (2-2), general formula (2-3), general formula (2-4), or formula (2-5).

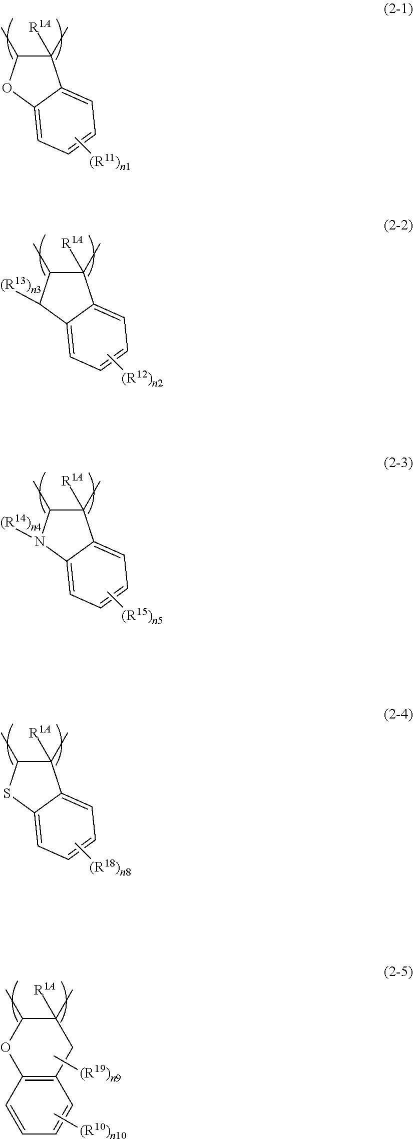

In general formulae, R¹⁰ to R¹⁵, R¹⁸to R¹⁹ each independently represent a substituent. n1, n2, n5, n8 and n10 each independently represent an integer of 0 to 4. n3 and n9 each independently represent an integer of 0 to 2. n4 represents an integer of 0 or 1. R^{1A} represents a hydrogen atom or an aliphatic group having 1 to 4 carbon atoms.

R¹⁰ to R¹⁵, R¹⁸, to R¹⁹

In general formulae (2-1) to (2-5), R¹⁰ to R¹⁵, R¹⁸ to R¹⁹ each independently represent a substituent.

The substituent is not particularly limited, but the following substituent T is exemplified. A preferable range of the substituent is also the same as that of the substituent T.

n1 to n10

n1, n2, n5, n8 and n10 each independently represent an integer of 0 to 4, and preferably from 0 to 2. n3 and n9 each independently represent 0 to 2, and preferably from 0 to 1. n4 represents 0 or 1, and preferably 0.

R^{1A}

R^{1A} represents a hydrogen atom or an aliphatic group having 1 to 4 carbon atoms. R^{1A} is not particularly limited, but a hydrogen atom, a methyl group or an ethyl group are preferred.

In the present invention, the polymer containing a repeating unit derived from a monomer represented by general formula (2) is preferably a coumarone resin containing three components represented by the following general formula (P-1) as repeating units. Herein, the coumarone resin means a collective term of copolymers composed of any one of or all of coumarone/indene/styrene in addition to copolymers which are synthesized from a petroleum residue and has a specific copolymerization ratio. The copolymers represented by the following general formula (P-1), therefore, fall into a category of the coumarone resin.

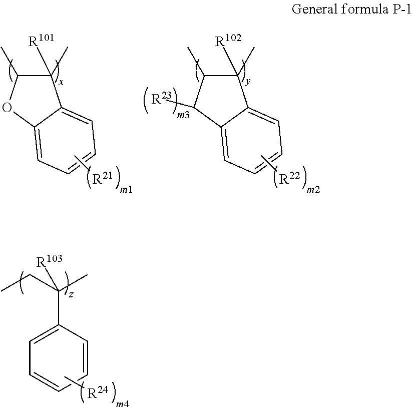

In general formula, R²¹, R²², R²³ and R²⁴ each independently represent a substituent. x, y and z represents a molar ratio to the all repeating units in the polymer, x represents a molar ratio of 0 to 40, y represents a molar ratio of 5 to 95, z represents a molar ratio of 0 to 70 . . . m1 and m2 represent an integer of 0 to 4, m3 represents an integer of 0 to 2, m4 represents an integer of 0 to 5, preferably from 0 to 3. R¹⁰¹ to R¹⁰³ represent a hydrogen atom or an aliphatic group having 1 to 4 carbon atoms.

R²¹ to R²⁴

R²¹, R22, R²³ and R²⁴ each independently represent a substituent. The substituent is not particularly limited, but the following substituent T is exemplified. A preferable range of the substituent is also the same as that of the substituent T.

R¹⁰¹ to R¹⁰³

R¹⁰¹ to R¹⁰³ represent a hydrogen atom or an aliphatic group having 1 to 4 carbon atoms. R¹⁰¹ to R¹⁰³ are not particularly limited, but a hydrogen atom, a methyl group and an ethyl group are preferred.

x, y and z

x represents a molar ratio of 0 to 40, preferably from 0 to 30, and more preferably from 0 to 20 . . . y represents a molar ratio of 5 to 95, preferably from 10 to 90, and more preferably from 30 to 90 . . . z represents a molar ratio of 0 to 70, preferably from 0 to 60, and more preferably from 0 to 50. A total of x, y and z is not necessary to be 100 (mole %), but when the total is less than 100, it means that other copolymer component(s) exists therein. Examples of the other copolymer component(s) include vinyl toluene, isopropenyl toluene, a-methyl styrene, alkylindenes, and dicyclopentadiene. The copolymerization ratio t of the other copolymer component(s) is preferably from 0 to 30, and more preferably from 0 to 20.

m1 to m4

m1 and m2 represent an integer of 0 to 4, and preferably from 0 to 2. m3 represents an integer of 0 to 2, and preferably 0. m4 represents an integer of 0 to 5, preferably from 0 to 3, and more preferably from 0 to 1.

The terminal group of the polymer containing a repeating unit derived from a monomer represented by general formula (2) may be any group, and typically a structure in which polymerization has been terminated by addition of a hydrogen atom to the vinyl group.

Hereinafter, specific examples of the polymer containing a repeating unit derived from a monomer represented by general formula (2) are shown. However, the present invention is not construed to be limited to them. The following structural formulae show chemical structures of the repeating units of main components and their constituent ratios, and as described above, other component(s) may be contained therein.

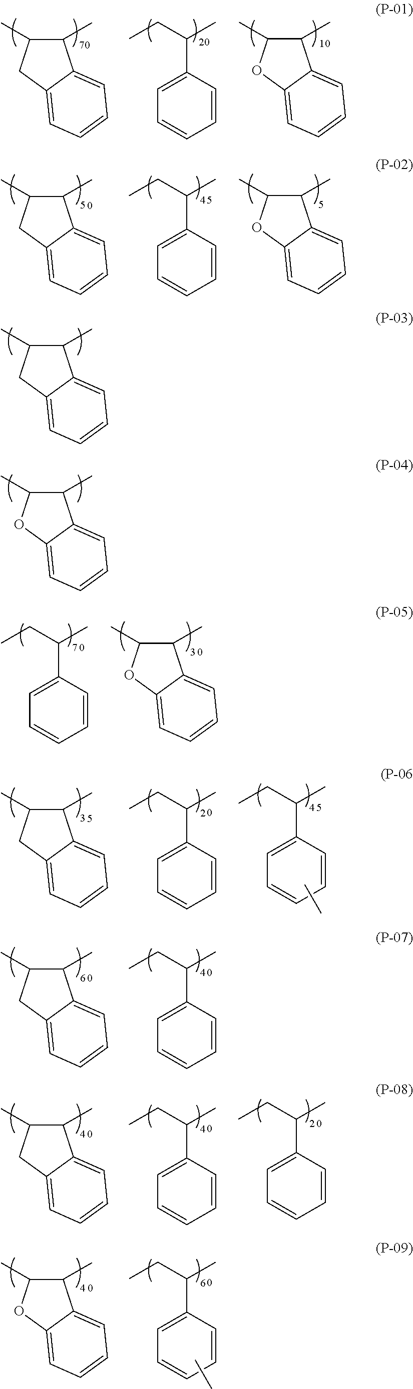

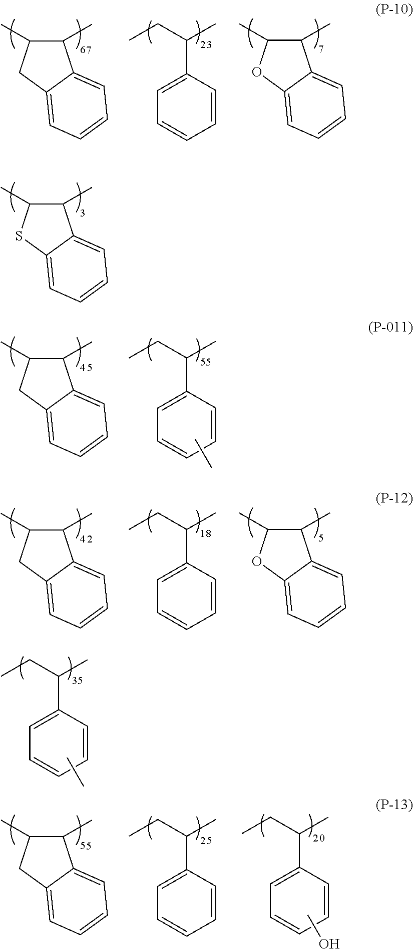

### (Weight-Average Molecular Weight)

The weight-average molecular weight of the polymer containing a repeating unit derived from a monomer represented by general formula (2) is preferably from 200 to 10,000, more preferably from 300 to 8,000, and most preferably from 400 to 4,000. When the weight-average molecular weight is above the lower limit, an effect of efficiently suppressing the water-vapor transmission ratio and water content ratio of the film can be expected. Meanwhile, when the weight-average molecular weight is below the upper limit, improvement of compatibility with the polymer (preferably a cellulose acylate) as the material for forming the optical film of the invention can be expected.

Unless it is explicitly stated otherwise, the weight-average molecular weight and the degree of dispersion are values obtained by GPC measurement (Gel Permeation Chromatography). The molecular weight is defined as polystyrene-converted mass-average molecular weight. The gel charged into the column used in the GPC method is preferably a gel having an aromatic compound as a repeating unit, and examples thereof include a gel including styrene-divinylbenzene copolymers. The column is preferably used in the form where 2 to 6 columns are connected. Examples of a solvent used include ether-based solvents such as tetrahydrofuran and the like, and amide-based solvents such as N-methylpyrrolidinone and the like. The measurement is preferably carried out at a flow rate of the solvent in the range of 0.1 to 2 mL/min, and most preferably in the range of 0.5 to 1.5 mL/min. By carrying out the measurement within these ranges, there is no load on an apparatus, and thus, the measurement can be carried out further efficiently. The measurement temperature is preferably carried out at 10° C. to 50° C., and most preferably at 20° C. to 40° C. A column and a carrier to be used can be properly selected, according to the property of a polymer compound to be measured.

In the present specification, the term “polymer” or “polymeric substance” is meant to include an oligomer that is a compound having a molecular weight of several hundreds in which, for example, several monomers have been polymerized, in addition to a polymer that is an ordinary high-molecular compound in which a lot of monomers have been polymerized. Further, the term. “polymer” or “polymeric substance” is meant, unless otherwise indicated, to include “copolymer” or “copolymeric substance”.

In the present specification, when the name of a chemical is called by putting the term “compound” at the foot of the chemical name, or when the chemical is shown by a specific name or a chemical formula, a showing of the compound is used to mean not only the compound itself, but also a salt, complex or ion thereof and the like. Further, the showing of the compound is also used to mean incorporation of derivatives modified by a predefined configuration to an extent necessary to obtain a desired effect. Further, in the present specification, when a specific atomic group is called by putting the term “group” at the foot of the specific atomic group with respect to the substituent, the group means that the group may have further an arbitrary substituent. This is also applied to a compound in which substitution or non-substitution is not explicitly stated. Examples of preferable substituents include the following substituent T.

The substituents T includes following substituents:

An alkyl group (preferably an alkyl group having 1 to 20 carbon atom(s), for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, for example, vinyl, allyl, and oleyl), an alkynyl group (preferably an alkynyl group having 2 to 20 carbon atoms, for example, ethynyl, butadiynyl, and phenylethynyl), a cycloalkyl group (preferably a cycloalkyl group having 3 to 20 carbon atoms, for example, cyclopropyl, cyclopentyl, cyclohexyl, and 4-methylcyclohexyl), an aryl group (preferably an aryl group having from 6 to 26 carbon atoms, for example, phenyl, 1-naphthyl, 4-methoxyphenyl, 2-chlorophenyl, and 3-methylphenyl), a heterocyclic group (preferably a heterocyclic group having 2 to 20 carbon atoms, for example, 2-pyridyl, 4-pyridyl, 2-imidazolyl, 2-benzimidazolyl, 2-thiazolyl, and 2-oxazolyl), an alkoxy group (preferably an alkoxy group having 1 to 20 carbon atom(s), for example, methoxy, ethoxy, isopropyloxy, and benzyloxy), an aryloxy group (preferably an aryloxy group having from 6 to 26 carbon atoms, for example, phenoxy, 1-naphthyloxy, 3-methylphenoxy, and 4-methoxyphenoxy), an alkoxycarbonyl group (preferably an alkoxycarbonyl group having 2 to 20 carbon atoms, for example, ethoxycarbonyl and 2-ethylhexyloxycarbonyl), an amino group (preferably an amino group having 0 to 20 carbon atom(s), for example, amino, N,N-dimethylamino, N,N-diethylamino, N-ethylamino, and anilino), a sulfonamide group (preferably a sulfonamide having 0 to 20 carbon atom(s), for example, N,N-dimethylsulfonamide, and N-phenylsulfonamide), an acyloxy group (preferably an acyloxy group having 1 to 20 carbon atom(s), for example, acetyloxy and benzoyloxy), a carbamoyl group (preferably a carbamoyl group having 1 to 20 carbon atom(s), for example, N,N-dimethylcarbamoyl and N-phenylcarbamoyl), an acylamino group (preferably an acylamino group having 1 to 20 carbon atom(s) for example, acetylamino and benzoylamino), a cyano group, and a halogen atom (for example, a fluorine atom, a chlorine atom, a bromine atom, and an iodine atom). Among them, an alkyl group, an alkenyl group, an aryl group, a heterocyclic group, an alkoxy group, an aryloxy group, an alkoxycarbonyl group, an amino group, an acylamino group, a cyano group, and a halogen atom are more preferable, an alkyl group, an alkenyl group, a heterocyclic group, an alkoxy group, an alkoxycarbonyl group, an amino group, an acylamino group, and a cyano group are particularly preferable.

In a case where the optical film of the present invention contains the polymer having a repeating unit derived from a monomer represented by the general formula (2), the polarizing element durability improvement effect is small when the addition amount of the polymer having a repeating unit derived from the monomer represented by the general formula (2) is extremely small and bleed out may occur when the addition amount thereof is extremely large. Therefore, the addition amount of the polymer is preferably in a range of 1 part by mass to 20 parts by mass, more preferably in a range of 1 part by mass to 10 parts by mass, still more preferably in a range of 2 parts by mass to 7 parts by mass, and particularly preferably in a range of 3 parts by mass to 6 parts by mass with respect to 100 parts by mass of the polymer (preferably, cellulose acylate) which is a material forming the optical film of the present invention.

### [Compound Represented by General Formula (3)]

A compound represented by the general formula (3) is described.

X-L-(R³)ₘ General Formula (3)

(In the general formula (3), X represents an acid group wherein the acid dissociation constant is 5.5 or less; L represents a single bond, or a di- or more valent linking group; R³ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms or a from 6 to 30 membered heterocyclic group, and each group may have a further substituent; m represents 1 in the case where L is a single bond, or represents the number expressed by:

(the valent number of L)−1

in the case where L is a di- or more valent linking group).

In the general formula (3), X represents an acid group wherein the acid dissociation constant is 5.5 or less, X is preferably a carboxyl group, a sulfonic acid group, a sulfinic acid group, a phosphate group, a sulfonimide group or an ascorbic acid group, further preferably a carboxyl group or a sulfonic acid group, most preferably a carboxyl group. In case where X represents an ascorbic acid group, 5 and 6-position hydrogen atoms of the ascorbic acid group preferably dissociate to bond to L.

In this specification, the data given in “Handbook of Chemistry” published by Maruzen may be employed for the acid dissociation constant.

In the general formula (3), R³ represents a hydrogen atom, an alkyl group having from 6 to 30 carbon atoms (which may have a substituent and may be a cycloalkyl group), an alkenyl group having from 6 to 30 carbon atoms (which may have a substituent), an alkynyl group having from 6 to 30 carbon atoms (which may have a substituent), an aryl group having from 6 to 30 carbon atoms (which may have a substituent) or a from 6 to 30 membered heterocyclic group (which may have a substituent). Example of the substituent includes a halogen atom, an alkyl group (which preferably has from 1 to 10 carbon atoms, more preferably from 1 to 6 carbon atoms) an aryl group, a heterocyclic group, an alkoxyl group, an aryloxy group, an alkylthio group, an arylthio group, an acyl group, a hydroxyl group, an acyloxy group, an amino group, an alkoxycarbonyl group, an acyl amino group, an oxycarbonyl group, a carbamoyl group, a sulfonyl group, a sulfamoyl group, a sulfonamide group, a sulfo group, a carboxyl group, etc.

R³ is preferably an aryl group having from 6 to 24 carbon atoms, a from 6 to 24 membered heterocyclic group, an alkyl group having from 8 to 24 carbon atoms, an alkenyl group having from 8 to 24 carbon atoms or an alkynyl group having from 8 to 24 carbon atoms, most preferably an aryl group having from 6 to 20 carbon atoms, a from 6 to 20 membered heterocyclic group, a straight chain alkyl group having from 10 to 24 carbon atoms or a straight chain alkenyl group having from 10 to 24 carbon atoms.

L in the general formula (3) preferably represents a single bond or a di- or more valent linking group selected from the following units, or a di- or more valent linking group formed by combining any of these units:

Unit: —O—, —CO—, —N(R²)— (where R² represents an alkyl group having from 1 to 5 carbon atoms), —CH(OH)—, —CH₂—, —CH═CH—, —SO₂—.

L in the general formula (3) is preferably a single bond or has an ester group-derived linking group (—COO—, —OCO—) or an amide group-derived linking group (—CON(R²)—, —N(R²)CO—) as the partial structure thereof.

L may further have a substituent; and not specifically defined, the substituent may be any one selected from those described above for the substituent that R1 may have. Of those, preferred are —OH and an alkyl group (more preferably an alkyl group substituted with a carboxylic acid).

R² may have a substituent. The substituent is not specifically limited. Examples of the substituent include the above examples of the substituent which R³ may have. Of those, preferred is a carboxyl group.

L is more preferably a linking group comprising a group derived from glycerin or a group derived from iminodicarboxylic acid (—N(CH₂COOH)(CH₂COOH)).

Preferably, L concretely has the following structure. In the following, p, q and r each indicate an integer of from 1 to 40, preferably from 1 to 20, more preferably from 1 to 10, even more preferably from 1to 6. More particularly preferably, q indicates an integer of from 2 to 4.

L1: —(CH₂)ₚ—CO—O—(CH₂)_{q}—O—;
L2: —(CH₂)ₚ—CO—O—(CH₂)_{q}—(CH(OH))—(CH₂)ᵣ—O—;
L3: —(CH₂)ₚ—CO—O—(CH₂)_{q}—(CH(OCO—R³⁰))—(CH₂)ᵣ—O—;
L4: —(CH₂)ₚ—CO—O—(CH₂)_{q}—(CH(OH))—(CH₂)ᵣ—O—CO—;
(CH2)ₚ—CO—O—(CH₂)_{q}—(CH(OCO—R³⁰))—(CH₂)ᵣ—O—CO—;
L5: —(CH₂)ₚ—N(CH₂COOH)—;
L6: —(CH₂)ₚ—N(CH₂COOH)—(CH₂)_{q}—;
L7: —(CH₂)ₚ—N(CH₂COOH)—(CH₂)_{g}—O—;
L8: —(CH₂)ₚ—N(CH₂COOH)—(CH₂)_{q}—CONH—;
L9: —(CH₂)ₚ—N(CH₂COOH)—(CH₂)_{q}—CONH—(CH₂)ᵣ—;
L10: —(CH₂)ₚ—N(CH₂COOH)—CO—;
L11: —(CH₂)ₚ—N(CH₂COOH)—CO—CH (CH₂COOH)—;
L12: —(CH₂)ₚ—N(CH₂COOH)—SO₂—.

R³⁰ in the specific examples of L has the same meaning as that of R³ in the general formula (3). Specifically, R³⁰ in the liking group of —(CH₂)ₚ—CO—O—(CH₂)_{q}—(CH(OCO—R³⁰))—(CH₂)ᵣ—O— is described inside L for convenience sake, but the linking group L means the part from which R³⁰ is removed. Accordingly, in this case, L is trivalent. This may be expressed as the general formula (3), X-L-(R³)₂ (wherein L is —(CH2)ₚ—CO—O—(CH₂)_{q}—(CH(OCO—))—(CH₂)ᵣ—O—), and in this case, the linking group L is a trivalent linking group.

Preferably, L and X bond to each other via an ester bond or an amide bond, more preferably via an ester bond. Preferably, X does not have an ester bond or an amide bond therein.

Preferably, L and R³ bond to each other via an ester bond, an ether bond or an amide bond, more preferably an ester bond or an amide bond, even more preferably an ester bond. Preferably, R³ does not have an ester bond, an ether bond or an amide bond therein.

Preferred examples of the organic acid of represented by the general formula (3) for use in the invention are given below.

### <<Fatty Acid>>

Myristic acid, palmitic acid, stearic acid, oleic acid, linolic acid, linolenic acid, recinoleic acid, undecanoic acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

### <<Dialkylsulfosuccinic Acid>>

Dioctylsulfosuccinic acid, dihexylsulfosuccinic acid, dicyclohexylsulfosuccinic acid, diamylsulfosuccinic acid, ditridecylsulfosuccinic acid.

### <<Polycarboxylic Acid Represented by General Formula (3′)>>

The organic acid represented by the general formula (3) is preferably a polycarboxylic acid represented by the following general formula (3′):

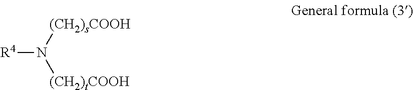

(In the formula, s and t each independently represent 1, 2 or 3, R⁴ represents a hydrogen atom, an alkyl group, an alkenyl group, an aryl group, an acyl group, an alkoxycarboxyl group, a carbamoyl group, an alkylsulfonyl group, an aryl sulfonyl group or a heterocyclic group, and each group may have a further substituent; with the proviso that R⁴ include the moiety of R³ in the general formula (3)).

Preferably, s and t each independently represent 1 or 2, more preferably represent 1.

R⁴ preferably represents an alkyl group having from 1 to 30 carbon atoms (which may have a substituent and may be a cycloalkyl group), an arylsulfonyl group having from 6 to 30 carbon atoms (which may have a substituent), an acyl group (which may have a substituent). More preferably, R⁴ represents an alkyl group having from 1 to 30 carbon atoms (which may have a substituent), still more preferably an alkyl group having from 1 to 24 carbon atoms (which may have a substituent), particularly preferably an alkyl group having from 1 to 20 carbon atoms.

Example of the substituent of R⁴ includes an alkyl group, a halogen atom, an aryl group, a heterocyclic group, an alkoxyl group, an aryloxy group, an alkylthio group, an arylthio group, an acyl group, a hydroxyl group, an acyloxy group, an amino group, an alkoxycarbonyl group, an acyl amino group, an oxycarbonyl group, a carbamoyl group, a sulfonyl group, a sulfamoyl group, a sulfonamide group, and a carboxyl group. The substituent of R⁴ is preferably an alkyl group, an acyl group, an aryl group and a carbamoyl group; more preferably an aryl group and a carbamoyl group.

The substituent of R⁴ may further have a substituent and a preferably range of the substituent is the same as the preferably range of the substituent of R⁴.

Most preferably, R⁴ is an alkyl group having from 1 to 24 carbon atoms having an aryl group as a substituent, or an alkyl group having from 1 to 24 carbon atoms having a carbamoyl group as a substituent in which the carbamoyl group is preferably substituted by an aryl group. The aryl group is preferably substituted by an alkyl group having from 1 to 10 carbon atoms, more preferably from 1 to 8 carbon atoms.

Examples of the carboxylic acid derivatives represented by the general formula (3′) include:

N-(2,6-diethylphenylcarbomoylmethyl)iminodiacetic acid represented by the following formula (31):

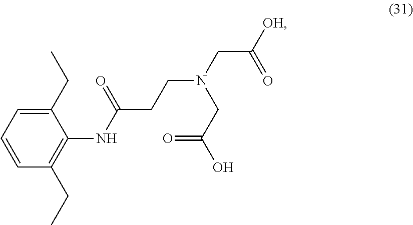 [SMILES: CCc1cccc(CC)c1NC(=O)CCN(CC(=O)O)CC(=O)O]

N-benzyliminodiacetic acid represented by the following formula (32):

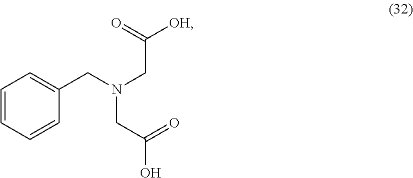 [SMILES: O=C(O)CN(CC(=O)O)Cc1ccccc1]

a compound represented by any one of the following formulae (33) to (40):

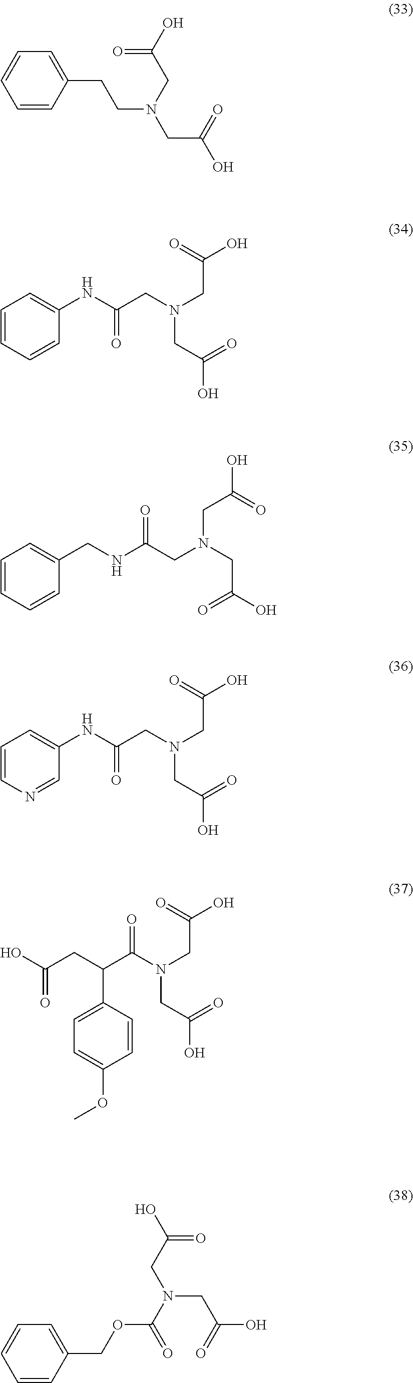 [SMILES: O=C(O)CN(CCc1ccccc1)CC(=O)O ; O=C(O)CN(CC(=O)O)CC(=O)Nc1ccccc1 ; O=C(O)CN(CC(=O)O)CC(=O)NCc1ccccc1 ; O=C(O)CN(CC(=O)O)CC(=O)Nc1cccnc1 ; COc1ccc(C(CC(=O)O)C(=O)N(CC(=O)O)CC(=O)O)cc1 ; O=C(O)CN(CC(=O)O)C(=O)OCc1ccccc1]

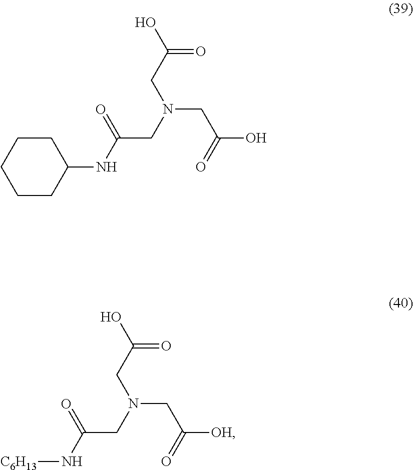

lauraminodiacetic acid represented by the following formula (41):

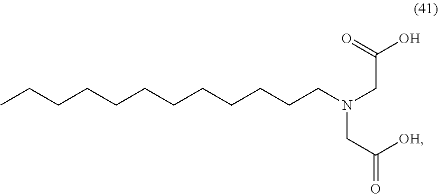 [SMILES: CCCCCCCCCCCCN(CC(=O)O)CC(=O)O]

a compound represented by any one of the following formulae (42) to (50):

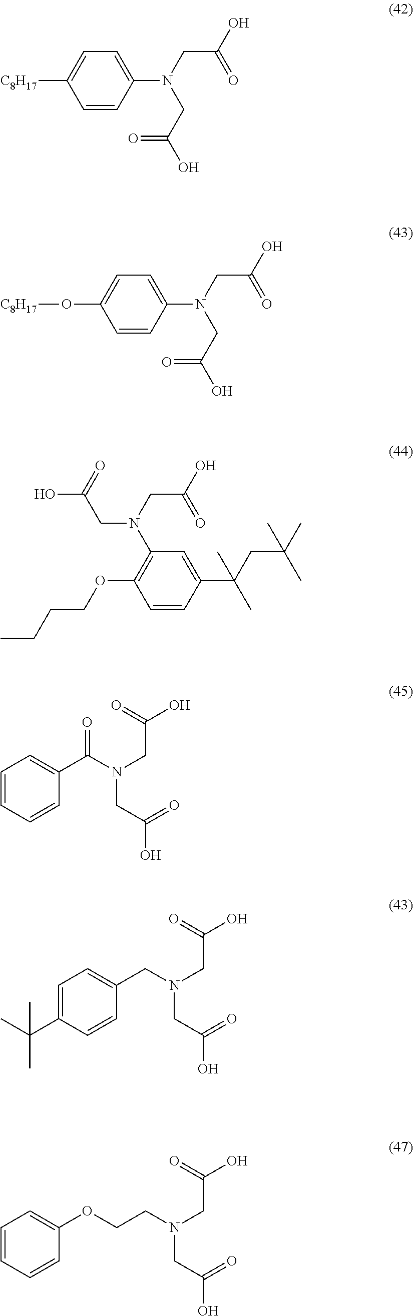

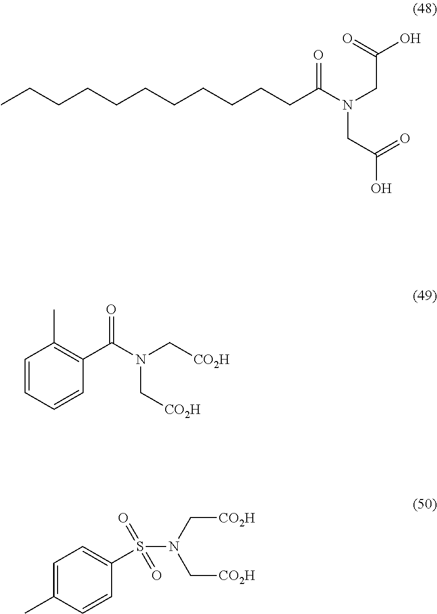 [SMILES: CCCCCCCCCCCC(=O)N(CC(=O)O)CC(=O)O ; Cc1ccccc1C(=O)N(CC(=O)O)CC(=O)O ; Cc1ccc(S(=O)(=O)N(CC(=O)O)CC(=O)O)cc1]

### <<Polycarboxylic Acid, and Partial Derivative of Polycarboxylic Acid>>

The compound represented by the general formula (3) is preferably a partial derivative of a polycarboxylic acid. In this description, the partial derivative of a polycarboxylic acid has a structure where one molecule of a fatty acid and a polycarboxylic acid are ester-bonded to one molecule of a polyalcohol, and is a compound having at lest one unsubstituted acid group derived from a polycarboxylic acid. In this description, the fatty acid means an aliphatic monocarboxylic acid. Specifically, the fatty acid in this description is not limited to a so-called higher fatty acid but includes a lower fatty acid having at most 12 carbon atoms such as acetic acid, propionic acid, etc.

The partial derivative of a polycarboxylic acid is preferably a partial derivative of a polycarboxylic acid. Above all, the compound represented by the general formula (3) comprises a structure wherein one molecule of fatty acid and one molecule of poly carboxylic acid are bonding to one molecule of polyalcohol by ester bond, wherein the structure has at least one of unsubstituted carboxyl group derived from the poly carboxylic acid. The polycarboxylic acid for the partial derivative of a polycarboxylic acid is not specifically defined, for which, for example, preferred are succinic acid, citric acid, tartaric acid, diacetyltartaric acid, malic acid, adipic acid.

The polyalcohol for the partial derivative of a polycarboxylic acid includes adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc. In those, preferred are glycerin and so it is preferably that the compound represented by the general formula (3) is a so-called organic acid glyceride.

The compound represented by the general formula (3) is preferably an organic acid glyceride (glycerin fatty acid organic acid ester) in which the acid group X of the organic acid bonds to the hydrophobic moiety R³ via the linking group L containing a glycerin-derived group. The organic acid glyceride in this description is a compound having a structure in which one or two of the three hydroxyl groups of glycerin form an ester bond with a fatty acid and the remaining one or two hydroxyl groups form an ester bond with a polycarboxylic acid and which has an acid group derived from the polycarboxylic acid.

Above all, more preferred is an organic acid monoglyceride or an organic acid diglyceride, and even more preferred is an organic acid monoglyceride. The organic acid monoglyceride in this description is a compound having a structure in which one of the three hydroxyl groups of glycerin forms an ester bond with a fatty acid and the remaining one or two hydroxyl groups form an ester bond with a polycarboxylic acid and which has an acid group derived from the polycarboxylic acid. The organic acid diglyceride in this description is a compound having a structure in which two of the three hydroxyl groups of glycerin form an ester bond with a fatty acid and the remaining one hydroxyl group forms an ester bond with a polycarboxylic acid and which has an acid group derived from the polycarboxylic acid.

Of the organic monoglyceride, more preferred is one having a structure in which one of the three hydroxyl groups of glycerin forms an ester bond with a fatty acid and the remaining one hydroxyl group is an unsubstituted hydroxyl group and the last one hydroxyl group forms an ester bond with a polycarboxylic acid and which has an acid group derived from the polycarboxylic acid. Preferably, the hydroxyl group ester-bonding to the fatty acid in the organic acid monoglyceride is in an asymmetric position (so-called α-monoglyceride position), and the hydroxyl group ester-bonding to the polyorganic acid in the organic acid monoglyceride is similarly in an asymmetric position (so-called α-monoglyceride position). Specifically, of the above-mentioned organic monoglyceride, preferred is one having a structure which has an unsubstituted hydroxyl group and in which the carbon atom directly bonding to the hydroxyl group that ester-bonds to the fatty acid and the carbon atom directly bonding to the hydroxyl group that ester-bonds to the polycarboxylic acid do not lie next to each other.

Of the above-mentioned organic monoglyceride, especially preferred is a polycarboxylic acid monoglyceride. The polycarboxylic acid monoglyceride has at least one unsubstituted carboxyl group of the polycarboxylic acid moiety and the other carboxyl groups are substituted with a monoglyceride. More preferred is a carboxyl group-having organic acid monoglyceride in which one fatty acid molecule and one polyvalent carboxylic acid molecule bond to one glycerin molecule.

The polycarboxylic acid for the monoglyceride of a polycarboxylic acid is not specifically defined, for which, for example, preferred are succinic acid, citric acid, tartaric acid, diacetyltartaric acid, malic acid, adipic acid.

The fatty acid for the monoglyceride of a polycarboxylic acid is not specifically defined, for which is preferred a saturated or unsaturated fatty acid having from 8 to 22 carbon atoms. Concretely mentioned are caprylic acid, capric acid, lauric acid, myristic acid, palmitic acid, stearic acid, behenic acid, oleic acid, etc.

The carboxyl group-having organic acid monoglyceride for use in the production method of the invention is described in detail hereinafter.

The carboxyl group-having organic acid monoglyceride usable in the invention may be obtained by reacting a polyorganic acid anhydride and a fatty acid monoglyceride generally according to the method described in JP-A 4-218597 and Japanese Patent No. 3823524.

The reaction is attained generally in the absence of a solvent, and for example, the reaction of succinic acid and a fatty acid monoglyceride having 18 carbon atoms may be attained at a temperature of around 120° C. and may be completed within about 90 minutes. Thus obtained, the organic acid monoglyceride is generally a mixture containing an organic acid, unreacted monoglyceride and diglyceride and other oligomers. In the invention, the mixture may be used directly as it is.

For increasing the purity of the carboxyl group-having organic acid monoglyceride, the carboxyl group-having organic acid monoglyceride may be isolated from the mixture through distillation or the like. The carboxyl group-having organic acid monoglyceride having a high purity is commercially available as a distilled monoglyceride, which may be used in the invention. Commercial products of the carboxyl group-having organic acid monoglyceride include, for example, Riken Vitamin's Poem K-37V (citric and oleic acid esters of glycerol), Kao's Step SS (succinic acid monoglyceride in which stearic acid/palmitic acid monoglyceride bonds to succinic acid), etc.

In a case where the optical film of the present invention contains the compound represented by the general formula (3), the addition amount of the compound represented by the general formula (3) is preferably in a range of 1 part by mass to 20 parts by mass, more preferably in a range of 1 part by mass to 10 parts by mass, and still more preferably in a range of 1 part by mass to 5 parts by mass with respect to 100 parts by mass of the polymer (preferably, cellulose acylate) which is a material forming the optical film of the present invention.

### <Compound Represented by General Formula (III)>

It is preferable that the optical film of the present invention contain the compound represented by the general formula (III), and it is more preferable that the compound represented by the general formula (III) be contained in a range of 1 part by mass to 20 parts by mass with respect to 100 parts by mass of the polymer (preferably, cellulose acylate) which is a material forming the optical film of the present invention.

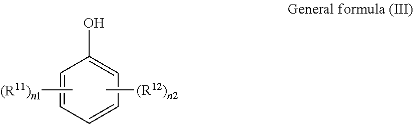

In the general formula (III), R¹¹ represents a substituent, R¹² represents a substituent represented by the general formula (III-1) shown below, n1 represents an integer from 0 to 4, when n1 represents 2 or more, plural R¹¹s may be the same or different from each other, and n2 represents an integer from 1 to 5, when n2 represents 2 or more, plural R¹²5 may be the same or different from each other.

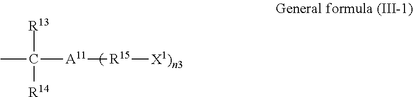

In the general formula (III-1), A¹¹ represents a substituted or unsubstituted aromatic ring, R¹³ and R¹⁴ each independently represents a hydrogen atom, an alkyl group having from 1 to 5 carbon atoms or a substituent represented by the general formula (III-2) shown below, R¹⁵ represents a single bond or an alkylene group having from 1 to 5 carbon atoms, X¹ represents a substituted or unsubstituted aromatic ring, and n3 represents an integer from 0 to 10, when n3 represents 2 or more, plural R¹⁵s and X¹s may be the same or different from each other.

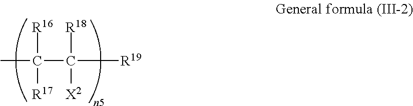

In the general formula (III-2), R¹⁶, R¹⁷, R¹⁸ and R¹⁹ each independently represents a hydrogen atom or an alkyl group having from 1 to 5 carbon atoms, X² represents a substituted or unsubstituted aromatic ring, and n5 represents an integer from 1 to 11, when n5 represents 2 or more, plural R¹⁶s, R¹⁷s, R¹⁸s and X²s may be the same or different from each other.

In the present invention, when the compound represented by the general formula (III) is added to the polymer (preferably, cellulose acylate) which is a material forming the optical film of the present invention, the moisture permeability can be decreased without degrading the haze, and thus, this is suitable for usage as a protective film of a polarizer. Details of the mechanism of obtaining such an effect are not clear, but it is considered that the compound represented by the general formula (III) has a strong interaction between a phenolic hydroxyl group and an aromatic ring. In the polymer (preferably, cellulose acylate) which is a material forming the optical film of the present invention, stabilization energy becomes larger in a case of hydrogen bonding with the compound represented by the general formula (III) rather than a case of hydrogen bonding with water.

Accordingly, when the polymer (preferably, cellulose acylate) which is a material forming the optical film of the present invention, which contains the compound represented by the general formula (III), is made into a film, since the compound represented by the general formula (III) easily enters the vicinity of the main chain of the polymer (preferably, cellulose acylate) which is a material forming the optical film of the present invention and water molecules have difficulty entering the vicinity of the main chain of the polymer (preferably, cellulose acylate) which is a material forming the optical film of the present invention, the optical film becomes hydrophobic because the interaction between water and the polymer (preferably, cellulose acylate) which is a material forming the optical film of the present invention becomes weak. When the optical film becomes hydrophobic, transmission of moisture through the polymer (preferably, cellulose acylate) which is a material forming the optical film of the present invention can be suppressed. Therefore, it is considered that transmission of moisture through a polarizing element is suppressed and polarizer durability in a high temperature and high humidity environment is improved when the optical film of the present invention, which contains the compound represented by the general formula (III), is used as a protective film of a polarizing element.

Further, it is considered that generation of quinones caused by oxidation of phenols which is considered as a cause of coloration can be suppressed using the compound represented by the general formula (IV) described below.

In the general formula (III), R¹¹ represents a substituent. The substituent is not particularly restricted and examples thereof include an alkyl group (preferably an alkyl group having from 1 to 20 carbon atoms, more preferably from 1 to 10 carbon atoms, for example, methyl, ethyl, isopropyl, tert-butyl, pentyl, heptyl, 1-ethylpentyl, benzyl, 2-ethoxyethyl or 1-carboxymethyl), an alkenyl group (preferably an alkenyl group having from 2 to 20 carbon atoms, for example, vinyl, allyl or oleyl), an alkynyl group (preferably an alkynyl group having from 2 to 20 carbon atoms, for example, ethynyl, butadiynyl or phenylethynyl), a cycloalkyl group (preferably a cycloalkyl group having from 3 to 20 carbon atoms, for example, cyclopropyl, cyclopentyl, cyclohexyl or 4-methylcyclohexyl), an aryl group (preferably an aryl group having from 6 to 26 carbon atoms, for example, phenyl, 1-naphthyl, 4-methoxyphenyl, 2-chlorophenyl or 3-methylphenyl), a heterocyclic group (preferably a heterocyclic group having from 2 to 20 carbon atoms, for example, 2-pyridyl, 4-pyridyl, 2-imidazolyl, 2-benzimidazolyl, 2-thiazolyl or 2-oxazolyl), an alkoxy group (preferably an alkoxy group having from 1 to 20 carbon atoms, for example, methoxy, ethoxy, isopropyloxy or benzyloxy), an aryloxy group (preferably an aryloxy group having from 6 to 26 carbon atoms, for example, phenoxy, 1-naphthyloxy, 3-methylphenoxy or 4-methoxyphenoxy), an alkoxycarbonyl group (preferably an alkoxycarbonyl group having from 2 to 20 carbon atoms, for example, ethoxycarbonyl or 2-ethylhexyloxycarbonyl), an amino group (preferably an amino group having from 0 to 20 carbon atoms, for example, amino, N,N-dimethylamino, N,N-diethylamino, N-ethylamino or anilino), a sulfonamide group (preferably a sulfonamide group having from 0 to 20 carbon atoms, for example, N,N-dimethylsulfonamide or N-phenylsulfonamide), an acyloxy group (preferably an acyloxy group having from 1 to 20 carbon atoms, for example, acethyloxy or benzoyloxy), a carbamoyl group (preferably a carbamoyl group having from 1 to 20 carbon atoms, for example, N, N-dimethylcarbamoyl or N-phenylcarbamoyl), an acylamino group (preferably an acylamino group having from 1 to 20 carbon atoms, for example, acetylamino or benzoylamino), a cyano group, a halogen atom (for example, a fluorine atom, a chlorine atom, a bromine atom or an iodine atom) and a hydroxy group.

R¹¹ is preferably an alkyl group having from 1 to 20 carbon atoms or a hydroxy group from the viewpoint of compatibility with the polymer (preferably a cellulose acylate) as the material for forming the optical film of the invention, more preferably an alkyl group having from 1 to 3 carbon atoms or a hydroxy group, and particularly preferably a hydroxy group or a methyl group.

R¹¹ may have one or more substituents selected from the substituents described above.

In the general formula (III), n1 represents an integer from 0 to 4, and is preferably an integer from 2 to 4 from the viewpoint of compatibility with the polymer (preferably a cellulose acylate) as the material for forming the optical film of the invention.

In the general formula (III), n2 represents an integer from 1 to 5, and is preferably an integer from 1 to 3 from the viewpoint of compatibility with the polymer (preferably a cellulose acylate) as the material for forming the optical film of the invention.

In the general formula (III), R¹² represents a substituent represented by the general formula (III-1).

The general formula (III-1) is described below.

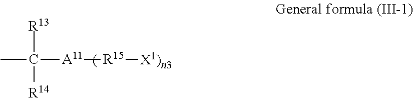

In the general formula (III-1), A¹¹ represents a substituted or unsubstituted aromatic ring, R¹³ and R¹⁴ each independently represents a hydrogen atom, an alkyl group having from 1 to 5 carbon atoms or a substituent represented by the general formula (III-2) shown below, R¹⁵ represents a single bond or an alkylene group having from 1 to 5 carbon atoms, X¹ represents a substituted or unsubstituted aromatic ring, and n3 represents an integer from 0 to 10, when n3 represents 2 or more, plural R¹⁵s and X¹s may be the same or different from each other.

In the general formula (III-1), A¹¹ represents a substituted or unsubstituted aromatic ring. The aromatic ring may be a heterocyclic ring containing a hetero atom, for example, a nitrogen atom, an oxygen atom or a sulfur atom.

Examples of A¹¹ include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thin ring, a pyridine ring, a piperidine ring, an oxazine ring, a morpholine ring, a thiazine ring, a pyridazine ring, a pyrimidine ring, a pyrazine ring, a piperazine ring and a triazine ring. Furthermore, other 6-membered ring or 5-membered ring may be condensed.

A¹¹ is preferably a benzene ring from the viewpoint of the polarizer stability.

The substituent which A¹¹ may have includes a halogen atom (for example, a fluorine atom, a chlorine atom, a bromine atom or an iodine atom), an alkyl group and a hydroxy group, and preferably an alkyl group having from 1 to 6 carbon atoms or a hydroxy group.

In the general formula (III-1), R¹³ and R¹⁴ each independently represents a hydrogen atom or an alkyl group having from 1 to 5 carbon atoms, preferably represents a hydrogen atom or an alkyl group having from 1 to 3 carbon atoms, and more preferably a hydrogen atom or a methyl group.

In the general formula (III-1), R¹⁵ represents a single bond or an alkylene group having from 1 to 5 carbon atoms. The alkylene group having from 1 to 5 carbon atoms may have a substituent. R¹⁵ is preferably an alkylene group having from 1 to 4 carbon atoms from the viewpoint of compatibility with the polymer (preferably a cellulose acylate) as the material for forming the optical film of the invention, and more preferably an alkylene group having from 1 to 3 carbon atoms. The substituent which R¹⁵ may have includes an alkyl group having from 1 to 5 carbon atoms (for example, methyl, ethyl, isopropyl or tert-butyl), a halogen atom (for example, a fluorine atom, a chlorine atom, a bromine atom or an iodine atom) and a hydroxy group.

In the general formula (III-1), X¹ represents a substituted or unsubstituted monovalent aromatic ring (a monovalent group from which one hydrogen atom is removed from an aromatic ring). The aromatic ring may be a heterocyclic ring containing a hetero atom, for example, a nitrogen atom, an oxygen atom or a sulfur atom. Examples of X¹ include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thin ring, a pyridine ring, a piperidine ring, an oxazine ring, a morpholine ring, a triazine ring, a pyridazine ring, a pyrimidine ring, a pyrazine ring, a piperazine ring and a triazine ring. Furthermore, other 6-membered ring or 5-membered ring may be condensed.

X¹ is preferably a benzene ring from the viewpoint of the polarizing element stability. The substituent which X¹ may have includes as same as the exemplified substituents described for A¹¹.

In the general formula (III-1), n3 represents an integer from 0 to 10, preferably an integer from 0 to 4 from the viewpoint of compatibility with the polymer (preferably a cellulose acylate) as the material for forming the optical film of the invention, more preferably an integer from 0 to 3, and is still more preferably an integer from 0 to 2, particularly preferably an integer of 0 or 1. When n3 represents an integer of 2 or more, plural groups represented by —(R¹⁵—X) may be the same as or different from each other and are connected to A¹¹.

The substituent represented by formula (III-1) is preferably a substituent represented by formula (III-1-1) shown below.

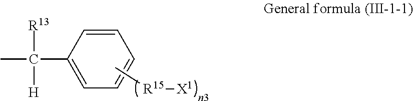

In the general formula (III-1-1), definitions of R¹³, R¹⁵ and X¹ are as same as those of R¹³, R¹⁵ and X¹ in the general formula (III-1), and the preferable ranges are also as same as those in the general formula (III-1).

n3 represents an integer from 0 to 10, and the preferable ranges are as same as n3 in the general formula (III-1).

The substituent represented by formula (III-1) is preferably a substituent represented by formula (III-1-2) shown below.

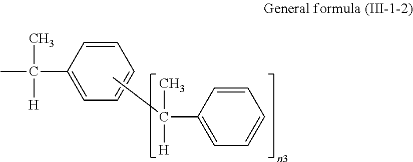

In the general formula (III-1-2), a definition of n3 is as same as those of n3 in the general formula (III-1-1), and the preferable ranges are also as same as those in the general formula (III-1-1).

The general formula (III-2) is described below.

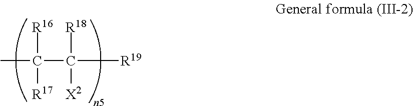

In the general formula (III-2), R¹⁶, R¹⁷, R¹⁸ and R¹⁹ each independently represents a hydrogen atom or an alkyl group having from 1 to 5 carbon atoms, X² represents a substituted or unsubstituted monovalent aromatic ring, and n5 represents an integer from 1 to 11, when n5 represents 2 or more, plural R¹⁶s, R¹⁷s, R¹⁸s and X²s may be the same or different from each other.

In the general formula (III-2), R¹⁶, R¹⁷, R¹⁸ and R¹⁹ each independently represents a hydrogen atom or an alkyl group having from 1 to 5 carbon atoms, and is preferably a hydrogen atom or an alkyl group having from 1 to 3 carbon atoms, and more preferably a hydrogen atom or a methyl group.

In the general formula (III-2), X² represents a substituted or unsubstituted monovalent aromatic ring, and specific examples and preferred ranges of the aromatic ring are also the same as those of X¹.

In the general formula (III-2), n5 represents an integer from 1 to 11, and is preferably an integer from 1 to 9, more preferably an integer from 1 to 7.

The substituent represented by the general formula (III-2) is preferably a substituent represented by the general formula (III-2-1) shown below.

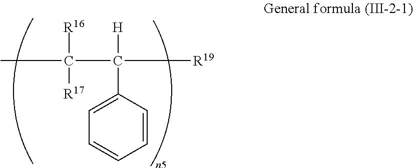

In the general formula (III-2-1), R¹⁶, R¹⁷, R19 and n5 have the same meanings as those defined in the general formula (III-2), respectively, and the preferred ranges thereof are also the same as those.

The substituent represented by the general formula (III-2) is preferably a substituent represented by the general formula (III-2-2) shown below.

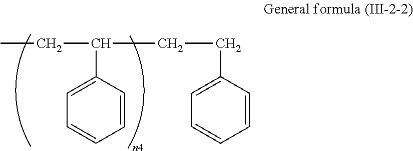

In the general formula (III-2-2), n4 represents an integer from 0 to 10.

In the general formula (III-2-2), n4 represents an integer from 0 to 10, and is preferably an integer from 0 to 8, more preferably an integer from 0 to 6.

The compound represented by the general formula (III) is preferably an embodiment wherein R¹² is a substituent represented by the general formula (III-1-2), n2 represents an integer from 1 to 3, and n3 represents an integer from 0 to 2.

Specific examples of the compound represented by the general formula (III) are set forth below, but the invention should not be construed as being limited thereto.

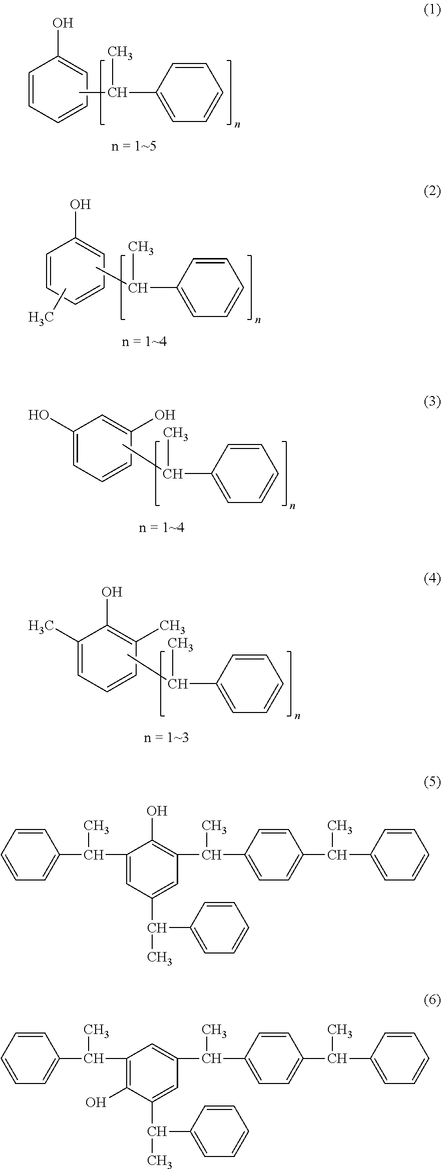

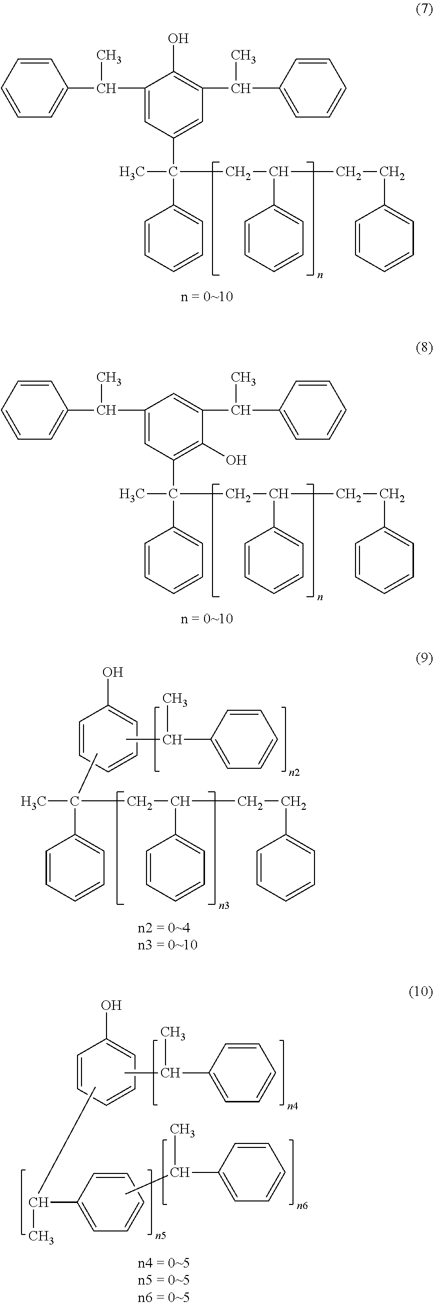

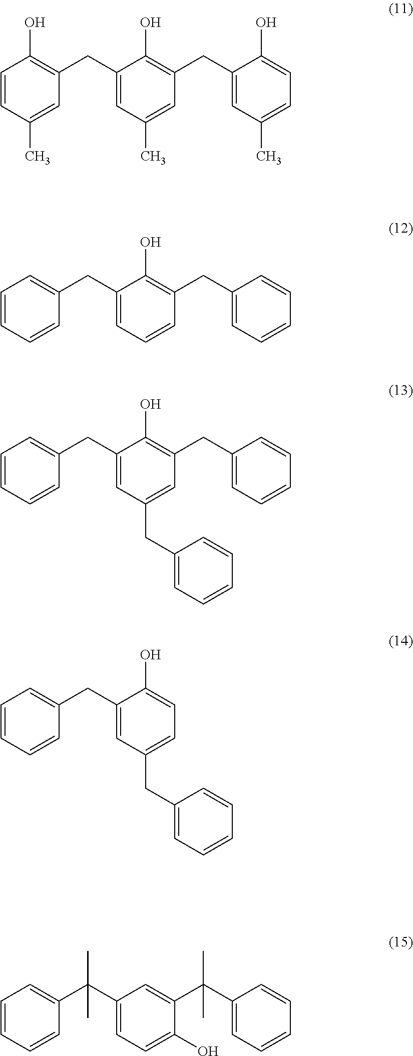

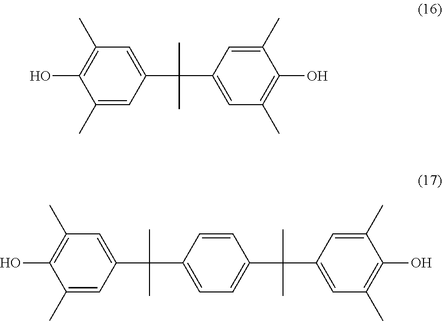

The weight average molecular weight of the compound represented by the general formula (III) is preferably in a range of 200 to 1200, more preferably in a range of 250 to 1000, and particularly preferably in a range of 300 to 800.

When the molecular weight is 200 or more, volatilization from the film is less, which is preferable. When the molecular weight is 1200 or less, the haze can be easily suppressed to be low, which is preferable.

The polarizing element durability improvement effect is small when the addition amount of the compound represented by the general formula (III) is extremely small and bleed out may occur when the addition amount thereof is extremely large. Therefore, the addition amount thereof is preferably in a range of 1 part by mass to 20 parts by mass, more preferably in a range of 1 part by mass to 10 parts by mass, still more preferably in a range of 2 parts by mass to 7 parts by mass, and particularly preferably in a range of 3 parts by mass to 6 parts by mass with respect to 100 parts by mass of the polymer (preferably, cellulose acylate) which is a material forming the optical film of the present invention.

In order to make it possible that the compounds represented by the general formula (III) having different number of hydroxy groups form hydrogen bonds at multiple points, a mixture may also be employed which contains at least two kinds of the compounds represented by the general formula (III) different from each other. As one example, a mixture containing a styrenated phenol obtained by alkylation of 1 to 3 moles of styrenes on phenol, a styrenated phenol obtained by further alkylation of styrene on a phenol moiety of an alkylated styrene and a styrenated phenol obtained by alkylation of an oligomer having about 2 to 4 units of styrenes on phenol is exemplified.

The compound represented by the general formula (III) can be ordinarily synthesized by adding one or more equivalents of styrene to one equivalent of phenol in the presence of an acid catalyst. Commercially available products may also be employed. Further, a mixture obtained by the synthesis method described above may be used as it is.

Examples of the commercially available product of the compound represented by the general formula (III) include styrenated phenol TSP produced by Sanko Co., Ltd., P1-1-25 produced by Nitto Chemical Co., Ltd. and NONFLEX WS produced by Seiko Chemical Co., Ltd.

It is preferable that the compound represented by the general formula (III) contain nickel in a content of 0.05 ppm to 0.50 ppm in a mass basis. As disclosed in JP-A-7-113003, nickel is mixed into a phenol-based compound during a production stage. It is assumed that an effect of suppression of working as a catalyst for oxidizing phenols can be obtained by adjusting the content of nickel in the compound represented by the general formula (III) to be in a range of 0.05 ppm to 0.50 ppm. Particularly, it is effective for increasing an effect of suppressing yellowing of the film of the compound represented by the general formula (IV) described below.

The content of nickel in the compound represented by the general formula (III) is preferably in a range of 0.14 ppm to 0.50 ppm, more preferably in a range of 0.14 ppm to 0.40 ppm, and still more preferably in a range of 0.14 ppm to 0.35 ppm in a mass basis.

The content of nickel in the compound represented by the general formula (III) can be adjusted using an ion exchange method or through direct addition.

### <<Compound Represented by General Formula (IV)>>

It is preferable that the optical film of the present invention contain the compound represented by the following general formula (IV) in a range of 0.5 parts by mass to 1.9 parts by mass with respect to 100 parts by mass of the compound represented by the general formula (III).

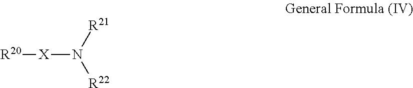

In the general formula (IV), R²⁰ represents a substituted or unsubstituted alkyl group having 3 to 20 carbon atoms or a substituted or unsubstituted alkenyl group; and R²¹ and R²² each independently represent a hydrogen atom, a substituted or unsubstituted alkyl group having 1 to 6 carbon atoms, or a substituted or unsubstituted alkenyl group, and R²¹ and R²² may be mutually bonded to each other to form a cyclic structure. X represents a single bond or a carbonyl group.

When an optical film obtained by adding a phenol-based component (compound represented by the general formula (III)) having a specific structure, which has an alkyl group with which an aromatic ring is substituted, as a substituent and a specific amine and amide-based compound (compound represented by the general formula (IV) to the polymer (preferably, cellulose acylate) which is a material forming the optical film of the present invention in a specific content ratio is used, decrease in orthogonal transmittance at the time of a high temperature and high humidity environment can be suppressed and yellowing of the film is particularly excellently suppressed.

The reason for which yellowing of the film and degradation of polarizing element durability are particularly excellently suppressed when the optical film obtained by adding the phenol-based compound having a specific structure and a specific amine and amide-based compound in a specific content ratio is not clear, but the reason can be assumed as follows.

That is, yellowing of the film is easily generated by phenols, which are added as a stabilizer, being changed into quinones through oxidation, but the polarizing element durability is degraded when amines and amides are added in a large amount for suppressing the generation of yellowing. The reason for this is assumed that an iodine adsorption property of amine and amide is excellent. Meanwhile, in regard to suppression of coloration, it is considered that the amines and amides work for inhibition of radical chain initiation (it is assumed that a metal or the like necessary for radical chain initiation is dropped due to a chelate effect), and the coloration is effectively suppressed even with an extremely small amount of amine and amide. It is considered that the coloration can be suppressed in a largely improved manner without substantially degrading the polarizing element durability by means of using the phenols and a small amount of amine and amides in combination.

In the general formula (IV), R²⁰ represents a substituted or unsubstituted alkyl group having 4 to 21 carbon atoms or a substituted or unsubstituted alkenyl group. As the alkyl group having 4 to 21 carbon atoms, an alkyl group having 6 to 20 carbon atoms is preferable, an alkyl group having 8 to 20 carbon atoms is more preferable, specifically, a lauryl group, a stearyl group, or an oleyl group is preferable and a lauryl group is more preferable. As the alkenyl group, an alkenyl group having 6 to 20 carbon atoms is preferable, an alkenyl group having 8 to 20 carbon atoms is more preferable, specifically, a lauryl group, a stearyl group, or an oleyl group is preferable and a lauryl group is more preferable.

In the general formula (IV), R²¹ and R²² each independently represent a hydrogen atom, a substituted or unsubstituted alkyl group having 1 to 6 carbon atoms, or a substituted or unsubstituted alkenyl group. As the alkyl group having 1 to 6 carbon atoms, an alkyl group having 1 to 5 carbon atoms is preferable, an alkyl group having 1 to 4 carbon atoms is more preferable, specifically, a methyl group, an ethyl group, a propyl group, or a butyl group is preferable, and an ethyl group, a propyl group, or a butyl group is more preferable. As the alkenyl group, an alkenyl group having 2 to 5 carbon atoms is preferable and an alkenyl group having 2 to 4 carbon atoms is more preferable.

In the general formula (IV), it is preferable that a substituent in a case where an alkyl group or an alkenyl group in R²⁰, R²¹, and R²² has a substituent be a group selected from the following substituent group (V).

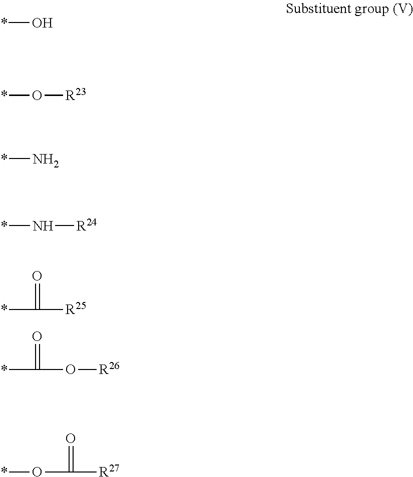

In the substituent group (V), R²³, R²⁴, R²⁵, R²⁶, and R²⁷ each independently represent an alkyl group having 1 to 6 carbon atoms. * represents a bonding site.

As R²³, R²⁴, R²⁵, R²⁶, or R²⁷, an alkyl group having 1 to 5 carbon atoms is preferable, an alkyl group having 1 to 4 carbon atoms is more preferable, specifically, a methyl group, an ethyl group, a propyl group, or a butyl group is preferable, and an ethyl group, a propyl group, or a butyl group is more preferable.

Among the substituent group (V), a hydroxyl group or a carbonyl group is particularly preferable and a hydroxyl group is most preferable.

In the general formula (IV), R²¹ and R²² may be mutually bonded to each other to form a cyclic structure. As a ring to be formed, piperidine or the like is exemplified.

It is preferable that the compound represented by the general formula (IV) be the compound represented by the general formula (VI) described below.

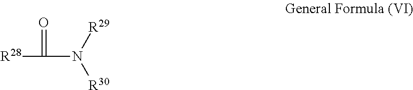

In the general formula (VI), R²⁸ represents a substituted or unsubstituted alkyl group having 3 to 20 carbon atoms or a substituted or unsubstituted alkenyl group; R²⁹ and R³⁰ each represent a hydrogen group, a substituted or unsubstituted alkyl group having 1 to 6 carbon atoms, or a substituted or unsubstituted alkenyl group.

In the general formula (VI), the specific examples and the preferable ranges of R²⁹ and R³⁰ are the same as those of R²¹ and R²² of the general formula (IV).

In the general formula (VI), R²⁸ represents a substituted or unsubstituted alkyl group having 3 to 20 carbon atoms or a substituted or unsubstituted alkenyl group, and a substituted or unsubstituted alkyl group having 6 to 20 carbon atoms or a substituted or unsubstituted alkenyl group is preferable. Examples of the alkyl group include propyl, isopropyl, n-butyl, t-butyl, pentyl, hexyl, heptyl, octyl, 2-ethylhexyl, nonyl, decyl, undecyl, and dodecyl, and examples of the alkenyl group include aryl and oleyl.

It is preferable that the compound represented by the general formula (IV) be the compound represented by the general formula (VII).

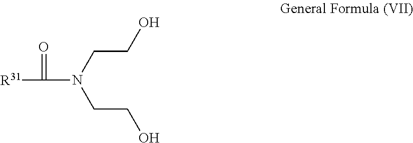

In the general formula (VII), R³¹ represents an alkyl group or an alkenyl group having 3 to 20 carbon atoms. The specific example and the preferable range of R²¹ are the same as those of R²⁸.

Specific examples of the compound represented by the general formula (IV) include lauryl diethanolamide, stearyl diethanolamide, and oleyl diethanolamide, and, among these, lauryl diethanolamide and stearyl diethanolamide are particularly preferable.

The optical film of the present invention contains the compound represented by the general formula (IV) preferably in a range of 0.5 parts by mass to 1.9 parts by mass, more preferably in a range of 0.7 parts by mass to 1.9 parts by mass, still more preferably in a range of 1.0 part by mass to 1.9 parts by mass, and particularly preferably in a range of 1.2 parts by mass to 1.9 parts by mass with respect to 100 parts by mass of the compound represented by the general formula (III). It is preferable that the content of the compound represented by the general formula (IV) be 0.5 parts by mass or more from the viewpoint of suppressing the yellowing of the film and preferable that the content thereof be 1.9 parts by mass or less from the viewpoint of the polarizing element durability with respect to 100 parts by mass of the compound represented by the general formula (III).

The compound represented by the general formula (1) is particularly preferable as a polarizing element durability modifier in terms of having small influence on wavelength dispersion through addition of the compound without increasing the retardation in the in-plane direction or the film thickness direction of the film.

### (Other Additive)

An anti-degradation agent (for example, antioxidant, peroxide decomposing agent, radical inhibitor, metal inactivating agent, acid trapping agent and amine) may be added to the optical film. The anti-degradation agent is described in Japanese Patent Application Laid-Open Nos. Hei 3-199201, Hei 5-194789, Hei 5-271471 and Hei 6-107854. The adding amount of the anti-degradation agent is preferably 0.01% to 1% by mass and more preferably 0.01% to 0.2% by mass, of the solution (dope) to be prepared from the viewpoint of exhibiting the effects of the present invention and inhibiting the bleed-out of the anti-degradation agent on the surface of the film.

Particularly preferable examples of the anti-degradation agent include butylated hydroxytoluene (BHT) and tribenzylamine (TBA).

An UV absorber may be added to the optical film. As the UV absorber, a compound described in Japanese Patent Application Laid-Open No. 2006-282979 (benzophenone, benzotriazole, and triazine) is preferably used. Two or more UV absorbers may be used in combination.

As the UV absorber, benzotriazole is preferred, and specifically, TINUVIN328, TINUVIN326, TINUVIN329, TINUVIN571, TINUVIN928, ADEKASTAB LA-31, and the like are exemplified.

The amount of the UV absorber to be added is preferably 10% or less, more preferably 3% or less, and most preferably 0.05% to 2%, by mass based on the polymer (preferably a cellulose acylate) as the material for forming the optical film of the invention.

### (Matting Agent Fine Particles)

It is preferred that the optical film of the present invention contains fine particles as a matting agent. Examples of the fine particles used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferred in that the turbidity is reduced, and silicon dioxide is particularly preferred. It is preferred that fine particles of silicon dioxide have an average primary particle diameter of 20 nm or less and an apparent specific gravity of 70 g/L or more. Those having a small average particle diameter of primary particles as from 5 nm to 16 nm are more preferred because the haze of the film may be reduced. The apparent specific gravity is preferably 90 g/L to 200 g/L, and more preferably 100 g/L to 200 g/L. A larger apparent specific gravity is preferred because a dispersion with a high concentration may be prepared and thus the haze and the agglomerated material are excellent. Preferred embodiments thereof are described in detail in Japan Institute of Invention and Innovation Journal of Technical Disclosure (Technical Publication No. 2001-1745, Mar. 15, 2001, published by Japan Institute of Invention and Innovation) pp. 35 to 36, and may be preferably used even in the optical film of the present invention.

### <Method of Producing Optical Film>

### (Organic Solvent of Dope Solution)

In the present invention, preferably, the optical film is produced using a solvent casting method, and a film is produced using a solution (dope) obtained by dissolving polymers including the polymer (preferably, cellulose acylate) which is a material forming the optical film of the present invention in an organic solvent in the solvent casting method. Hereinafter, the method of producing the optical film of the present invention will be described using a preferable example in which the polymer which is a material forming the optical film of the present invention is cellulose acylate, but the polymer which is a material forming the optical film of the present invention is not limited to cellulose acylate and the optical film of the present invention can be produced using the following production method when a polymer other than cellulose acylate is used.

The organic solvent preferably used as a main solvent of dope is not particularly limited as long as the organic solvent is a solvent that dissolves polymers including the polymer (preferably, cellulose acylate) which is a material forming the optical film of the present invention, but a solvent selected from ester, ketone, and ether having 3 to 12 carbon atoms, and halogenated hydrocarbon having 1 to 7 carbon atoms is preferable. Each of ester, ketone, and ether may have a cyclic structure. A compound having any two or more functional groups (that is, —O—, —CO—, and —COO—) of ester, ketone, and ether can be used as a main solvent and may have other functional groups such as an alcoholic hydroxyl group.

As described up to this point, for the optical film of the present invention, a chlorine-based hydrocarbon halide may be used as a main solvent. As described in Japan Institute of Invention and Innovation Journal of Technical Disclosure No. 2001-1745 (pp. 12 to 16), a non-chlorine-based solvent may be used as a main solvent, and the optical film of the present invention is not particularly limited.

Solvents in dope solutions and optical films as well as dissolving methods thereof are disclosed in the following patents, which are a preferred aspect. These solvents and methods are disclosed, for example, in Japanese Patent Application Laid-Open Nos. 2000-95876, 2000-95877, Hei 10-324774, Hei 8-152514, Hei 10-330538, Hei 9-95538, Hei 9-95557, Hei 10-235664, 2000-63534, Hei 11-21379, Hei 10-182853, Hei 10-278056, Hei 10-279702, Hei 10-323853, Hei 10-237186, Hei 11-60807, Hei 11-152342, Hei 11-292988, Hei 11-60752, Hei 11-60752, and the like. According to these patents, there are descriptions not only about solvents preferable for dissolving the cellulose acylate used for the present invention but also about properties of the solutions or substances that may added to the solutions, and the descriptions are a preferred aspect even in the present invention.

### (Dissolution Process)

The dissolution method in the preparation of the dope solution is not particularly limited, and any method such as a room-temperature dissolving method, a cold dissolving method, a hot dissolving method, and a combination thereof may be used. With respect to each process of preparation of a dope solution and concentration and filtration of solutions according to the dissolution process, the preparation processes described in detail in Japan Institute of Invention and Innovation Journal of Technical Disclosure (Technical Publication No. 2001-1745, Mar. 15, 2001, published by Japan Institute of Invention and Innovation), pp. 22 to 25, are preferably used in the present invention.

### (Casting, Drying and Winding Processes)

Next, a method for manufacturing a film by using a dope solution will be described. A method and apparatus for manufacturing an optical film of the present invention may use solution casting film formation methods and solution casting film formation devices that are provided in the manufacture of a cellulose triacetate film in the related art. A dope solution prepared in a dissolver (tank) is once stored in a storage tank, and bubbles included in the dope are defoamed to perform a final preparation. The resulting dope is fed from a dope exit to a pressure die through for example, a pressure constant displacement gear pump capable of precisely metering and transporting solutions according to the number of rotations and uniformly cast from an inlet member (slit) of the pressure die on an endlessly moving metal support of a casting portion and at a peeling point where the metal support makes almost one revolution, a half-dried doping film (also referred to as a web) is peeled off the metal support. Both edges of the web thus obtained are fixed therebetween by a clip, conveyed and dried by a tenter while the width thereof is maintained, and the film subsequently obtained is mechanically conveyed with a roll group in a heating apparatus and wound in the form of a roll by a winder to a predetermined length. The temperature in drying in the heating apparatus is preferably from 100° C. to 180° C., more preferably from 110° C. to 160° C. The combination of the tenter and the drying apparatus of the roll group varies depending on the purpose. In another aspect, it is possible to employ various methods of forming a film by using a solvent casting method such as a method including the following process: the doping extruded from a die gels onto a drum which cools the above-described metal support to 5° C. or less, and then at a time point when the metal support makes almost one revolution, is removed from the drum, conveyed while being stretched by a pin-type tenter, and dried.

In the optical film of the present invention, it is preferable to perform casting by a co-casting method. That is, a casting having a plurality of layers is performed by extruding at least two or more dopes which are different in the amount of addition simultaneously or sequentially from an inlet member of a die.

In the co-casting, the haze of the film or the content of additives on the surface of the film may be controlled even by controlling the concentration of a solid of a layer in contact with the casting support. For example, it may be difficult to transfer the surface shape of the casting support by reducing the concentration of a solid in the layer. That is, the drying rate in the dope (web) including large amounts of additives is fast and thus when the film is peeled off from the casting support, the residual solvent amount is small and it is difficult to perform a leveling in the subsequent process. Accordingly, the film haze is easily increased, but the surface shape (unevenness) responsible for an increase in haze is negligibly small and thus it is possible to reduce the haze by locally reducing the concentration of a solid.

Meanwhile, the diffusivity of additives may be inhibited by increasing the concentration of the solid in the layer and thus the contamination of the casting support may be inhibited or the content of the additives on the surface of the film may be reduced. As described above, these factors may be appropriately controlled while a balance with other required characteristics is confirmed.

When the co-casting is performed, for example, a feed blocking method by which the number of layers is easily controlled or a multi-manifold method which has excellent thickness precision in each layer may be used, and a feed blocking method may be more preferably used in the present invention.

In a solution casting film formation method used in a functional protective film which is an optical member for electronic displays or a silver halide photographic light-sensitive material, which are the primary uses of the optical film of the invention, a coating device is often combined with a solution casting film formation device to provide a surface processing on a film such as an undercoat layer, an antistatic layer, an anti-halation layer, a protective layer, and the like. The devices are described in detail in Japan Institute of Invention and Innovation Journal of Technical Disclosure (Technical Publication No. 2001-1745, Mar. 15, 2001, published by Japan Institute of Invention and Innovation), pp. 25 to 30, and classified into casting (including co-casting), metal support, drying, peeling, and the like, which may be preferably used in the present invention.

### (Heat Treatment Process)

In the manufacturing method of the optical film, a process of subjecting the optical film to additional heat treatment may be applied if necessary. Although the effects of the heat treatment process are not particularly limited, it is believed that for example, a coefficient of hygroscopic expansion may be changed by performing heat treatments in which temperature and tensile strength are controlled according to the kind of the film to change the orientation or crystallization of the polymer (preferably a cellulose acylate) as the material for forming the optical film of the invention molecules to be included.

### (Surface Treatment)

The optical film of the present invention may be subjected to a surface treatment to achieve the improvement of the adhesion between the optical film and respective functional layers (for example, an undercoat layer and a back layer). For example, a glow discharge treatment, an ultraviolet irradiation treatment, a corona treatment, a flame treatment, and an acid or alkali treatment may be used. As used herein, the glow discharge treatment may be a low temperature plasma caused under a low pressure gas of 10⁻³ Torr to 20 Torr, and further preferably a plasma treatment under an atmospheric pressure. The plasma excitable gas denotes a gas that may be excited into plasma under the conditions as described above, and includes argon, helium, neon, krypton, xenon, nitrogen, carbon dioxide, flons such as tetrafluoromethane, mixtures thereof, and the like. These gases are described in detail in Japan Institute of Invention and Innovation Journal of Technical Disclosure (Technical Publication No. 2001-1745, Mar. 15, 2001, published by Japan Institute of Invention and Innovation) pp. 30 to 32, which may be preferably used in the present invention.

### <Use of Optical Film>

(Lamination with Functional Layer)

The optical film of the present invention is applied to, for example, an optical use and a photographic photosensitive material as the uses thereof. In particular for the optical use, it is preferred that the film is used as a protective film of a polarizer and thus the polarizer is used in a liquid crystal display device. The liquid crystal display devices are preferably of TN, IPS, FLC, AFLC, OCB, STN, ECB, VA and HAN.

In this case, imparting of various functional layers is carried out on the optical film of the present invention. Examples thereof include an antistatic layer, a curable resin layer (transparent hard coat layer), an antireflection layer, an easy-to-adhere layer, an antiglare layer, an optically-compensatory layer, an alignment layer, a liquid crystal layer, and the like. The functional layers and materials thereof may include a surfactant, a slipping agent, a matting agent, an antistatic layer, a hard coat layer, and the like, and are described in details in Japan Institute of Invention and Innovation Journal of Technical Disclosure (Technical Publication No. 2001-1745, Mar. 15, 2001, published by Japan Institute of Invention and Innovation) pp. 32 to 45, which may be preferably used in the invention.

### (Retardation Film)

The optical film of the present invention may be used as a retardation film. The “retardation film” is generally used in display devices such as liquid crystal display device, and the like, means an optical material having optical anisotropicity, and is synonymous with a retardation plate, an optically compensatory film, an optically compensatory sheet, and the like. In the liquid crystal display device, the retardation film is used for the purpose of enhancing the contrast of a display screen or improving viewing angle characteristics or tint.

Retardation may be freely controlled by using the optical film of the present invention, and thus a retardation film having excellent adhesion with a polarizer may be manufactured.

The optical film of the present invention may be used as a retardation film by stacking a plurality of optical films of the present invention or stacking the optical film of the present invention with a film out of the present invention to control Re or Rth appropriately. The stacking of films may be performed by using an adhesive or an adhesion bond.

In some cases, the optical film of the present invention may be used as a support of a retardation film, and then, by providing an optically anisotropic layer including a liquid crystal and the like thereon, a retardation film is formed. The optically anisotropic layer applied to the retardation film may be formed as, for example, a composition containing a liquid crystalline compound, a polymer film having birefringence, and the optical film of the present invention. In this case, when the manufacturing method of the optical film of the present invention is performed as a subsequent process of an optically anisotropic layer forming process, it is preferred to bring an organic solvent in contact with a surface opposite to the surface on which the optically anisotropic layer is formed.

As the liquid crystalline compound, discotic liquid crystalline compounds or rod-like liquid crystalline compounds are preferred.

Examples of the discotic liquid crystal compounds that may be used as the liquid crystalline compounds include compounds described in various documents (for example, C. Destrade et al., Mol. Cryst. Liq. Cryst., vol. 71, page. 111 (1981); edited by the Chemical Society of Japan, Quarterly Issue Chemistry Review Paper, No. 22, Chemistry of Liquid Crystal, Ch. 5, Ch. 10, Sec. 2 (1994); B. Kohne et al., Angew. Chem., vol. 96, page 70 (1984); J. M. Lehn et al., J. Soc. Chem. Comm., page 1794 (1985); and J. Zhang et al., J. Am. Chem. Soc., vol. 116, page 2655 (1994)).

In the optically anisotropic layer, the discotic liquid crystalline molecules are preferably fixed in an aligned state, and are most preferably fixed by a polymerization reaction. The polymerization of discotic liquid crystalline molecules is described in Japanese Patent Application Laid-Open No. Hei 8-27284. In order to fix the discotic liquid crystalline molecules by polymerization, it is necessary to bind a polymerizable group to the discotic core of the discotic liquid crystalline molecules as a substituent. However, when the polymerizable group is directly bound to the discotic core, it becomes difficult to maintain the orientation state for the polymerization reaction. Thus, a linking group is introduced between the discotic core and the polymerizable group. The discotic liquid crystal molecules having a polymerizable group are described in Japanese Patent Application Laid-Open No. 2001-4387.

Examples of the rod-like liquid crystalline compounds that may be used as the liquid crystalline compounds include azomethines, azoxy compounds, cyanobiphenyls, cyanophenyl esters, benzoic esters, phenyl esters of cyclohexanecarboxylic acid, cyanophenylcyclohexanes, cyano-substituted phenylpyrimidines, alkoxy-substituted phenylpyrimidines, phenyldioxanes, tolans and alkenylcyclohexylbenzonitriles. As the rod-like liquid crystalline compounds, not only low molecular liquid crystalline compounds, but also high molecular liquid crystalline compounds may be useful.

In the optically anisotropic layer, the discotic liquid crystalline molecules are preferably fixed in an aligned state, and are most preferably fixed by a polymerization reaction. Examples of polymerizable rod-like liquid crystalline compounds that may be used in the present invention include compounds described, for example, in Makromol. Chem., vol. 190, page 2255 (1989), Advanced Materials, vol. 5, page 107 (1993), U.S. Pat. Nos. 4,683,327, 5,622,648, and 5,770,107, International Publication Nos. WO95/22586, WO95/24455, WO97/00600, WO98/23580, and WO98/52905, and Japanese Patent Application Laid-Open Nos. Hei 1-272551, Hei 6-16616, Hei 7-110469, Hei 11-80081, 2001-328973, and the like.

### (Hardcoat Film, Antiglare Film and Antireflective Film)

The optical film of the present invention is applicable to a hardcoat film, an antiglare film or an antireflective film. Any one or all of a hardcoat layer, an antiglare layer, and an antireflective layer may be provided on one side or both sides of the optical film of the present invention for the purpose of improving visibility of flat panel displays, such as LCDs, PDPs, CRTs, ELs, and the like. Preferred embodiments of such applications as an antiglare film and an antireflective film are described in detail in Japan Institute of Invention and Innovation Journal of Technical Disclosure (Technical Publication No. 2001-1745, Mar. 15, 2001, published by Japan Institute of Invention and Innovation) pp 54 to 57, and the optical film of the present invention may be preferably used.

### (Transparent Substrate)

Because the optical film of the present invention may be formed with an optical anisotropy close to zero, has excellent transparency and experiences a small change in retardation even though the film is maintained under a moist heat environment, the optical film may also be used as a substitute for a liquid crystal cell glass substrate of a liquid crystal display device, that is, a transparent substrate for sealing a driving liquid crystal.

The transparent substrate for sealing a liquid crystal is required to have excellent gas barrier properties, and thus a gas barrier layer may be provided on the surface of the optical film of the present invention if necessary. The form or material of the gas barrier layer is not particularly limited, but methods of vapor depositing SiO2 or the like on at least one side of the optical film of the present invention, or providing a coat layer of a polymer having relatively high gas barrier properties, such as vinylidene chloride-based polymer or vinyl alcohol-based polymer, or stacking these inorganic and organic layers are contemplated, and the methods may be appropriately used.

For use as a transparent substrate for sealing a liquid crystal, a transparent electrode for driving a liquid crystal by application of a voltage may be provided. The transparent electrode is not particularly limited, but a transparent electrode may be provided by stacking a metal film, a metal oxide film, and the like on at least one side of the optical film of the present invention. Among them, from the viewpoint of transparency, electrical conductivity, and mechanical properties, metal oxide films are preferred, and among the metal oxide films, a thin film of indium oxide containing mainly tin oxide and zinc oxide in an amount of 2% to 15% may be preferably used. The details of these technologies are disclosed, for example, in Japanese Patent Application Laid-Open Nos. 2001-125079, 2000-227603, and the like.

### [Polarizer]

The polarizer of the present invention includes at least one optical film of the present invention.

The optical film of the present invention may be used as a protective film of the polarizer (the polarizer of the invention). The polarizer of the present invention includes a polarizing element (sometimes referred to as a polarizing film) and two polarizer protective films (optical films) that protect both sides thereof, and the optical film of the present invention is particularly preferably used as a polarizer protective film on at least one side.

When the optical film of the present invention is used as the polarizer protective film, the optical film of the present invention is preferably subjected to a surface treatment for hydrophilization, such as the above described surface treatments (also described in Japanese Patent Application Laid-Open Nos. Hei 6-94915 and Hei 6-118232), and for example, a glow discharge treatment, a corona discharge treatment, an alkali saponification treatment, and the like are preferably performed. As the surface treatment, an alkali saponification treatment is used most preferably.

Further, as the polarizing element, for example, a polarizing element in which a polyvinyl alcohol film is immersed in an iodine solution and then stretched can be used. When a polarizing element in which a polyvinyl alcohol film is immersed in an iodine solution and then stretched is used, surface treated surfaces of the optical film of the present invention can be directly adhered to the both surfaces of the polarizing element using an adhesive. In the present invention, it is preferable that the optical film of the present invention be directly adhered to the polarizing element in this manner. As the adhesive, an aqueous solution of polyvinyl alcohol or polyvinyl acetal (for example, polyvinyl butyral) or latex of a vinyl-based polymer (for example, polybutyl acrylate) can be used. A particularly preferable adhesive is an aqueous solution of completely saponified polyvinyl alcohol.

In the polarizer of the present invention, the thickness of the polarizing element is preferably in a range of 1 μm to 40 μm, more preferably in a range of 5 μm to 35 μm, and particularly preferably in a range of 10 μm to 30 μm. By adjusting the thickness of the polarizing element to be within the above-described range, when the polarizing element is adhered to the optical film of the present invention having the film thickness and the thermal contraction in the specific ranges through the adhesive, it is possible to suppress the generation of light unevenness having a circular shape or an elliptical shape on the display surface when the optical film is applied to a thin liquid crystal display device.

A liquid crystal display device generally has a liquid crystal cell disposed between a pair of polarizers and therefore contains four polarizer protective films. While the optical film of the present invention may be used as any one or more of the four polarizer protective films, it is particularly advantageous to use the optical film of the present invention as the protective film disposed between the polarizing element and the liquid crystal layer (liquid crystal cell) in a liquid crystal display device. A transparent hardcoat layer, an antiglare layer, an antireflective layer, and the like may be provided on the protective film disposed on the side opposite to the side of the optical film of the present invention via the polarizing element is particularly preferably used as the polarizer protective film of the outermost surface of the display side of a liquid crystal display device.

The polarizer is preferably composed of a polarizing element and a protective film that protects both sides thereof and combines and is further composed of a protective film on one side of the polarizer and a separate film on the other side thereof. Both the protective film and the separate film are used for the purpose of protecting the polarizer during shipment of the polarizer or inspection of the product. In this case, the protective film is attached for the purpose of protecting the surface of the polarizer, and the polarizer is used on the side opposite to the surface in contact with the liquid crystal plate. The separate film is used for the purpose of covering the adhesion bond layer which is attached to the liquid crystal plate, and used on the side which attaches the polarizer to the liquid crystal plate.

In the liquid crystal display device, a substrate including a liquid crystal is usually disposed between two polarizers, but the polarizer protective film to which the optical film of the present invention is applied may provide excellent display qualities even though the protective film may be disposed in any portion. In particular, a transparent hardcoat layer, an antiglare layer, an antireflective layer, and the like are provided on the protective film on the outermost surface on the display side of a liquid crystal display device, and thus the optical film of the invention is particularly preferably used on this portion.

### (Polarizing Element Durability)

Orthogonal transmittance CT of the polarizing element at a wavelength of 410 nm is measured using UV3100PC (manufactured by Shimadzu Corporation), and an average value of 10 times of measurement is used.

A polarizer durability test is performed as follows in a state in which the polarizer is adhered to glass through an adhesive. Two samples (approximately 5 cm. x 5 cm) prepared by adhering the polarizer onto the glass are created. In the single plate orthogonal transmittance measurement, the film side of each sample is set to face a light source and then measured. Two samples are respectively measured and the average value thereof is set as the orthogonal transmittance of the polarizing element.

Next, the orthogonal transmittance is measured using the same technique after storage in an environment of a temperature of 60° C. and at a relative humidity of 95% for 900 hours. The change of the orthogonal transmittance before and after aging is acquired and set as polarizing element durability.

Here, the change amount of the orthogonal transmittance is calculated by the following equation.

ΔT/T(%)={(orthogonal transmittance after durability test−orthogonal transmittance before durability test)}/orthogonal transmittance before durability test

The preferable range of the change of the orthogonal transmittance is preferably 20% or less, more preferably 15% or less, and still more preferably 10% or less.

### [Liquid Crystal Display Device]

The optical film and polarizer of the present invention may be used for liquid crystal display devices of various display modes. Hereinafter, each of the liquid crystal modes in which these films may be used will be described. Among these modes, the optical film and polarizer of the present invention may be preferably used in all the modes, but are particularly preferably used for liquid crystal display devices of VA mode and IPS mode. These liquid crystal display devices may be any one of a transmissive type, a reflective type, and a semi-transmissive type.

### (TN Type Liquid Crystal Display Device)

The optical film of the present invention is preferably used as a support of a retardation film in a TN type liquid crystal display device having a TN mode liquid crystal cell. TN mode liquid crystal cells and TN type liquid crystal display devices have long been known. The retardation film used in TN type liquid crystal display devices is described in Japanese Patent Application Laid-Open Nos. Hei 3-9325, Hei 6-148429, Hei 8-50206, and Hei 9-26572, and Mori et al., papers (Jpn. J. Appl. Phys., vol. 36 (1997), p. 143 or Jpn. J. Appl. Phys. Vol. 36 (1997), p. 1068).

### (STN Type Liquid Crystal Display Device)

The optical film of the present invention may be used as a support of a retardation film in an STN type liquid crystal display device having an STN mode liquid crystal cell. In common STN type liquid crystal display devices, rod-like liquid crystal molecules in the liquid crystal cell are twisted in the range of 90° to 360°, and the product (Δnd) of the refractive index anisotropy (Δn) of the rod-like crystal molecules and the cell gap (d) are in the range of 300 nm to 1500 nm. The retardation film used in STN type liquid crystal display devices is described in Japanese Patent Application Laid-Open No. 2000-105316.

### (VA Type Liquid Crystal Display Device)

The optical film of the present invention is particularly advantageously used as a retardation film or a support of the retardation film in a VA type liquid crystal display device having a VA mode liquid crystal cell. The VA type liquid crystal display device may have an alignment division mode as described, for example, in Japanese Patent Application Laid-Open No. Hei 10-123576. In these aspects, a polarizer using the optical film of the present invention contributes to the enlargement of viewing angle and the improvement of contrast.

### (IPS Type Liquid Crystal Display Device and ECB Type Liquid Crystal Display Device)

The optical film of the present invention is particularly advantageously used as a retardation film, a support of the retardation film, or a protective film of a polarizer in an IPS type liquid crystal display device having an IPS mode liquid crystal cell and an ECB type liquid crystal display device having an ECB mode liquid crystal cell. When black is displayed, these modes are an aspect in which the liquid crystal materials are aligned substantially in parallel with each other, and the liquid crystal molecules are aligned in parallel with the surface of the substrate in no voltage applied state to achieve a black display. In these aspects, a polarizer using the optical film of the present invention contributes to the enlargement of viewing angle and the improvement of contrast.

It is preferred to have |Rth| of less than 25 nm, but it is particularly preferred that the optical film has Rth of 0 nm or less in a region of 450 nm to 650 nm, because tint changes are small.

In the embodiment, among protective films of the polarizer at the top and the bottom of a liquid crystal cell, the polarizer using the optical film of the present invention as the protective film (protective film on a cell side) arranged between the liquid crystal cell and the polarizer is preferably used at the top and the bottom of the liquid crystal cell. Further, more preferably, an optically anisotropic layer, whose retardation value of an optically anisotropic layer between the protective film of the polarizer and the liquid crystal cell is set to double the value of Δnd or less of a liquid crystal layer, is arranged on one side.

The liquid crystal display device of the present invention is an IPS liquid crystal display device and the liquid crystal cell preferably indicates the following Expression (6).

250 nm≦Δnd(550)≦350 nm Expression (6)

(In Expression (6), Δnd (550) represents the product of refractive index anisotropy (Δn) and a cell gap (d) of a rod-shaped liquid crystalline molecule of a liquid crystal cell at a wavelength 550 nm).

Δnd (550) is preferably in a range of 280 nm to 340 nm and more preferably in a range of 290 nm to 330 nm.

### (OCB Type Liquid Crystal Display Device and HAN Type Liquid Crystal Display Device)

The optical film of the present invention is also advantageously used as a support of a retardation film in an OCB type liquid crystal display device having an OCB mode liquid crystal cell or an HAN type liquid crystal display device having an HAN mode liquid crystal cell. In the retardation film used in the OCB type or the HAN type liquid crystal display devices, it is preferred that the direction in which the absolute retardation value is the lowest exists in neither an in-plane direction nor the nominal direction thereof. The optical properties of the retardation film used in the OCB type liquid crystal display device or the HAN type liquid crystal display device are also determined by optical properties of the optically anisotropic layer, optical properties of the support, and the arrangement between the optically anisotropic layer and the support. A retardation film used in the OCB type liquid crystal display device or the HAN type liquid crystal display device is described in Japanese Patent Application Laid-Open No. Hei 9-197397. There is also a description in a paper (Mori, et al., Japanese Journal of Appl. Phys., vol. 38 (1999) p. 2837).

### (Reflective Type Liquid Crystal Display Device)

The optical film of the present invention is also advantageously used as a retardation film in reflective type liquid crystal display devices of a TN type, an STN type, a HAN type, and a GH (Guest-Host) type. These display modes have long been known. The TN type reflective liquid crystal display devices are described in Japanese Patent Application Laid-Open No. Hei 10-123478, International Publication No. WO98/48320, and Japanese Patent No. 3022477. A retardation film used in the reflective type liquid crystal display device is described in International Publication No. WO00/65384.

### (Other Liquid Crystal Display Devices)

The optical film of the present invention is also advantageously used as a support of a retardation film in axially symmetric aligned microcell (ASM) type liquid crystal display devices having an ASM mode liquid crystal cell. An ASM mode liquid crystal cell is characterized in that the cell thickness is maintained by a resin spacer whose position is adjustable. Other properties are the same as those of a TN mode liquid crystal cell. With respect to the ASM mode liquid crystal cell and the ASM type liquid crystal display device, there is a description in a paper by Kume et al. (SID 98 Digest, p. 1089 (1998)).

The optical film of the present invention may be used as a retardation film or a support of the retardation film which is preferably used as an image display panel which may display 3D image displays. Specifically, a λ/4 layer may be formed on the entire surface of the optical film of the present invention or, for example, a patterned retardation layer having different birefringence refractive index alternately in a line type may be formed. The optical film of the present invention has a smaller dimensional change to a change in humidity than that of the cellulose acylate film in the related art, and thus the optical film may be preferably used over the latter.

### Examples

Hereinafter, characteristics of the present invention will be described in more detail with reference to Examples. The materials, amounts, ratios, operations, order of operations, and the like shown in the Examples below may appropriately be modified without departing from the spirit of the present invention. Therefore, the scope of the present invention should not be construed as being limited by specific Examples shown below.

### Examples 1 to 20 and Comparative Examples 1 to 9

### (1) Preparation of Cellulose Acylate Resin Through Synthesis

Sulfuric acid (7.8 parts by mass with respect to 100 parts by mass of cellulose) was added as a catalyst and then acetic acid was added to perform an acylation reaction at 40° C.

Next, the total substitution degree and the 6-position substitution degree were prepared by adjusting the catalystic amount of the sulfuric acid, the water content, and the aging time. The degree of acryl substitution of cellulose acylate was acquired by a method described in carbohydr. Res. 273(1995)83-91 (Tezuka and others) using ¹³C-NMR.

The temperature for aging was 40° C. Further, the low molecular weight components of the cellulose acylate were washed by acetone and then removed. The number average molecular weight of the obtained cellulose acylate was 96000 and the weight average molecular weight was 260000.

### 2) Preparation of Dope

### (Preparation of Cellulose Acylate Solution

The following compositions were put in a mixing tank, stirred to dissolve each component, and heated at 90° C. for approximately 10 minutes, and then filtered using filter paper having an average pore size of 34 μm and a sintered metallic filter having an average pore size of 10 μm.

### Cellulose Acylate Solution

Cellulose acylate listed in Table 2 below: total 100.0 parts by mass
Plasticizer listed in Tables 1 and 2 below (Unit of the amount listed in Tables 1 and 2: parts by mass)
Nitrogen-containing aromatic compound listed in Table 2 below (Unit of the amount listed in Table 2: parts by mass)
Methylene chloride: 451.0 parts by mass
Methanol: 39.0 parts by mass

TABLE 1

| | Polycondensed ester | | | | | | | |
|---|---|---|---|---|---|---|---|---|
| Kinds of | | | | | | | | Number average |
| plasticizer | Dicarboxylic acid | | Diol ingredient | | | | Hydroxyl value | molecular |
| # | AA unit | SA unit | EG unit | PG unit | BG unit | Both terminals | [mgKOH/g] | weight |
| 1 | 100 | 0 | 100 | 0 | 0 | Not blocked | 112 | 1000 |
| 2 | 100 | 0 | 100 | 0 | 0 | Acetyl | 0 | 1000 |
| 3 | 100 | 0 | 70 | 30 | 0 | Acetyl | 0 | 1000 |
| 4 | 100 | 0 | 50 | 50 | 0 | Acetyl | 0 | 1000 |
| 5 | 100 | 0 | 70 | 20 | 10 | Acetyl | 0 | 1000 |
| 6 | 100 | 0 | 80 | 0 | 20 | Acetyl | 0 | 1000 |
| 7 | 0 | 100 | 100 | 0 | 0 | Not blocked | 112 | 1000 |
| 8 | 0 | 100 | 100 | 0 | 0 | Acetyl | 0 | 1000 |
| 9 | 100 | 0 | 100 | 0 | 0 | Acetyl | 0 | 800 |
| 10 | 100 | 0 | 70 | 30 | 0 | Acetyl | 0 | 800 |
| 11 | 100 | 0 | 50 | 50 | 0 | Acetyl | 0 | 800 |
| 12 | 100 | 0 | 100 | 0 | 0 | Acetyl | 0 | 600 |
| 13 | 100 | 0 | 50 | 50 | 0 | Acetyl | 0 | 600 |
| 14 | 100 | 0 | 50 | 50 | 0 | Benzoyl | 0 | 1000 |
| 15 | 100 | 0 | 100 | 0 | 0 | Acetyl | 0 | 300 |
| 16 | 100 | 0 | 100 | 0 | 0 | Acetyl | 0 | 500 |
| 17 | 100 | 0 | 100 | 0 | 0 | Acetyl | 0 | 2500 |
| 18 | 100 | 0 | 100 | 0 | 0 | Acetyl | 0 | 3000 |
| 19 | 100 | 0 | 100 | 0 | 0 | Acetyl | 0 | 4000 |
| 20 | 100 | 0 | 50 | 50 | 0 | Isononyl | 0 | 1000 |
| 21 | 100 | 0 | 50 | 50 | 0 | Butynyl | 0 | 1000 |
| 22 | 100 | 0 | 50 | 50 | 0 | Propionyl | 0 | 1000 |

In Table 1 above, AA represents adipic acid, SA represents succinic acid, EG represents ethylene glycol, PG represents 1,2-propylene glycol, BG represents butylene glycol, and Bz represents a benzoyl group.

Compounds A and B having the following structures were used as the nitrogen-containing aromatic compounds.

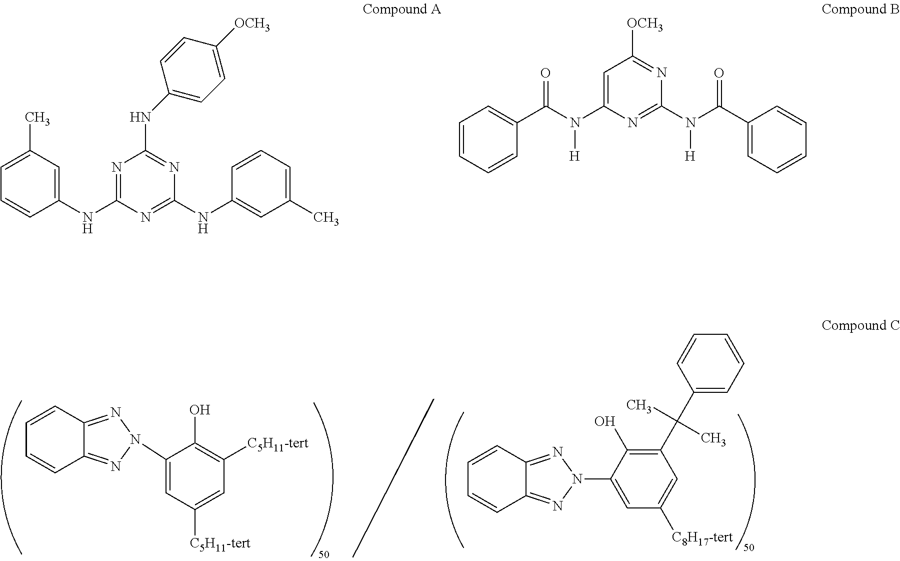

Compounds D, E, and F having the following structures were used as the polarizing element durability modifiers.

### Compound D:

The polarizing element durability modifier (1-10)

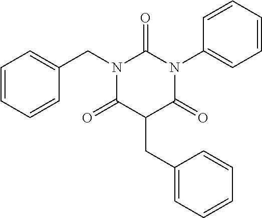 [SMILES: O=C1C(Cc2ccccc2)C(=O)N(c2ccccc2)C(=O)N1Cc1ccccc1]

### Compound E:

The polarizing element durability modifier (1-11)

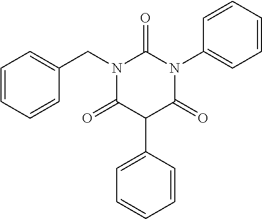 [SMILES: O=C1C(c2ccccc2)C(=O)N(c2ccccc2)C(=O)N1Cc1ccccc1]

### Compound F:

The polarizing element durability modifier (1-1)

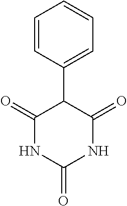 [SMILES: O=C1NC(=O)C(c2ccccc2)C(=O)N1]

### (Preparation of Matting Agent Dispersion Liquid)

Subsequently, the following compositions containing the cellulose acylate solution created using the above-described method were put in a disperser, thereby preparing a matting agent dispersion liquid.

### Matting Agent Dispersion Liquid

Matting agent (Aerosil R972): 0.2 parts by mass

Methylene chloride: 72.4 parts by mass

Methanol: 10.8 parts by mass

Cellulose acylate solution of each Example and each Comparative Example: 10.3 parts by mass

### (Preparation of Dope for Producing Film)

100 parts by mass of the cellulose acylate solution and the amount in which matting agent fine particles of the matting agent dispersion liquid becomes 0.20 parts by mass with respect to the cellulose acylate resin were mixed to prepare a dope for producing a film.

### (3) Flow Casting

The dope for producing a film described above was flow-cast using a band cast machine. Further, the band is made of stainless steel (SUS).

### (4) Drying

The web (film) obtained through flow casting was peeled off from the band and then dried in a tenter apparatus, which transports the web by clipping both ends thereof using a clip, at 100° C. for 20 minutes.

Subsequently, the web was dried by being transported to a dry zone at the drying temperature listed in Table 2 below.

Further, the drying temperature means the film surface temperature of the film.

### (5) Winding

Subsequently, each film after being cooled to room temperature was wound to prepare 10 rolls having a roll width of 1340 mm and a roll length of 3700 mm under the above-described conditions for the purpose of determining the production suitability.

One roll from among 10 rolls continuously produced was cut to have an interval of 100 m and a length of 1 m to make samples (width: 1280 mm) and then set as the optical films of each Example and each Comparative Example, and then each measurement was performed thereon.

### (6) Measurement and Evaluation of Properties of Optical Film

A measurement method and an evaluation method of properties of the optical films of each Example and each Comparative Example are shown below.

### (Retardation)

Five points (a central portion, edge portions (positions at 5% of each of the total width from both ends), and 2 points at the intermediate portions of the central portion and the edge portions of a film) in a width direction of the film were sampled at every 100 m in a longitudinal direction, samples having a size of 5 cm angle were cut, and an average value at each point, which was evaluated by the above-described method was calculated to obtain Rth at each wavelength.

Next, the films were undergone thermo treatment and Rth at each wavelength was calculated according to the above-described method.

Obtained results were shown on Table 3 below.

### (Dimensional Change Rate)

First, after the humidity of the film was adjusted at 25° C. and a relative humidity of 60% for 24 hours, the sound speed maximum direction was acquired as a direction in which the propagation speed of the longitudinal wave vibration of the ultrasonic pulse became the maximum using an orientation measuring machine (SST-2500, manufactured by Nomura Shoji Co., Ltd.).

Next, the thermal contraction rate before and after 24 hours passed at 60° C. and at a relative humidity of 90% of the film in the sound speed maximum direction and a direction orthogonal to the sound speed maximum direction was acquired using the following Equation.

Thermal contraction rate={(L′−LO)/LO}×100

(LO represents a film length before 24 hours passed at 60° C. and at a relative humidity of 90% and L′ represents a film length after 24 hours passed at 60° C. and at a relative humidity of 90% and then the humidity thereof was adjusted at 25° C. and at a relative humidity of 60% for 30 minutes.)

Obtained results are listed in Table 3 below.

### (Winding Quality or Production Suitability)

Process contamination at the time of production and the appearance of the obtained roll were visually inspected, and evaluation was performed according to the following criteria.

A: Process contamination was not recognized and loosened winding, accretion, or wrinkles was not visually recognized from the appearance of the roll.

B: Process contamination due to material volatilization was recognized and loosened winding, accretion, or wrinkles was visually recognized from the appearance of the roll.

Obtained results are listed in Table 3 below.

### 7) Manufacture of Polarizer

### (Saponification of Film

Each of the optical films prepared in Examples and Comparative Examples and Fuji Tack TD60UL (manufactured by Fuji Film Corporation) were immersed in a 4.5 mol/L sodium hydroxide aqueous solution (saponification liquid) which was temperature-controlled at 37° C. for 1 min, and then the film was washed with water, immersed in a 0.05 mol/L sulfuric acid aqueous solution for 30 sec, and again passed through a washing bath. And then, water removal was performed three times with an air knife and dried in a drying zone at 70° C. for a retention time of 15 sec to manufacture a saponified film.

### (Manufacture of Polarizer)

A 20 μm thick polarizing element was prepared by imparting the difference in circumferential speed to two pairs of nip rolls and stretching the rolls in a longitudinal direction in accordance with Example 1 of Japanese Patent Application Laid-Open No. 2001-141926.

### (Lamination)

The thus-obtained polarizing element was interposed in between one sheet selected from the saponified optical films and the Fuji Tack TD60UL, and then the films were laminated roll-to-roll via a 3% polyvinyl alcohol (manufactured by Kuraray Co., Ltd., PVA-117H) aqueous solution as an adhesion bond such that the axis of polarization and the longitudinal direction of the optical films are orthogonal to each other, thereby making a polarizer.

### (8) Mounting Evaluation on Liquid Crystal Display Device

Polarizers having liquid crystal cells inserted therebetween were peeled off from a commercially available liquid crystal display television set (slim type 42 type liquid crystal display TV set of IPS mode, Δnd=320 nm), and the polarizers manufactured above was re-laminated to the liquid crystal cells with an adhesive such that the optical film of the invention described in Table 2 is disposed on the liquid crystal cell side. Display characteristics of the re-assembled liquid crystal display television set were identified to confirm the luminance intensity and tint from the front surface and the inclined surface, and as a result, characteristics equivalent to those before the polarizer was peeled off were observed.

### (Level of Light Unevenness in Inclined Direction at Initial Time)

Luminance unevenness at the time of a black display when observed from the inclined direction of a device was observed, and evaluation was performed according to the following criteria.

S: 4.5 cd/m² or less

A: in a range of more than 4.5 cd/m² to 5.0 cd/m² or less

B: in a range of more than 5.0 cd/m² to 5.5 cd/m² or less

C: more than 5.5 cd/m²

The evaluation results are listed in Table 4 below.

(Level of Light Unevenness Having Circular Shape or Elliptical Shape in Front Surface Direction after Thermal Treatment)

Further, light unevenness having a circular shape or an elliptical shape was evaluated using samples which were held in an environment of at 50° C. and at a relative humidity of 90% for 72 hours, moved to an environment of 25° C. and at a relative humidity of 60%, continuously lighted up in a black display state, visually observed after 24 hours, and then observed from the front surface direction of a device according to the following criteria.

S: Unevenness having a circular shape or an elliptical shape was not visually recognized at all in an environment of luminance 100 1×

A: Unevenness having a circular shape or an elliptical shape was not almost visually recognized in an environment of luminance 100 1×

B: Unevenness having a circular shape or an elliptical shape was slightly visually recognized in an environment of luminance 100 1×

C: Unevenness having a circular shape or an elliptical shape was clearly visually recognized in an environment of luminance 100 1×

D: Unevenness having a circular shape or an elliptical shape was clearly visually recognized in an environment of luminance 300 1×

Evaluation results are listed in Table 4.

When the level thereof is C or higher, the device can be used.

(Level of Light Unevenness Having Circular Shape or Elliptical Shape in Inclined Direction after Thermal Treatment)

Light unevenness having a circular shape or an elliptical shape was evaluated using samples which were held in an environment of at 50° C. and at a relative humidity of 90% for 72 hours, moved to an environment of 25° C. and at a relative humidity of 60%, continuously lighted up in a black display state, visually observed after 24 hours, and then observed in a direction with an azimuth angle of 45 degrees and a direction with a polar angle of 70 degrees from the front surface of the device at a time of a black display according to the following criteria.

S: Unevenness having a circular shape or an elliptical shape was not recognized by visual at all in an environment of luminance 100 1×

A: Unevenness having a circular shape or an elliptical shape was not almost visually recognized in an environment of luminance 100 1×

B: Unevenness having a circular shape or an elliptical shape was slightly visually recognized in an environment of luminance 100 1×

C: Unevenness having a circular shape or an elliptical shape was clearly visually recognized in an environment of luminance 100 1×

D: Unevenness having a circular shape or an elliptical shape was clearly visually recognized in an environment of luminance 300 1×

Evaluation results are listed in Table 4.

When the level thereof is C or higher, the device can be used.

### (Polarizer Evaluation)

Orthogonal transmittance CT of the polarizing elements prepared in each Example and each Comparative Example in the above at a wavelength of 410 nm was measured using UV3100PC (manufactured by Shimadzu Corporation), and an average value of values obtained by 10 times of measurement was used.

A polarizing element durability test was performed as follows in a state in which the polarizer was adhered to glass through an adhesive. Two samples (approximately 5 cm×5 cm) created by adhering the polarizer onto the glass were prepared. In single plate orthogonal transmittance measurement, the film side of each sample was set to face a light source and then measured. Two samples were respectively measured and the average value was set as the orthogonal transmittance of the polarizing element.

Next, the orthogonal transmittance was measured using the same technique after storage in an environment of a temperature of 60° C. and at a relative humidity of 95% for 900 hours. The change of the orthogonal transmittance before and after aging was acquired and then set as polarizing element durability. The results are listed in Table 4 below.

Here, the change amount of the orthogonal transmittance is calculated by the following equation.

ΔT/T(%)={(orthogonal transmittance after durability test−orthogonal transmittance before durability test)}/orthogonal transmittance before durability test

When the change of the orthogonal transmittance is 20% or less, the polarizer can be used.

Evaluation results are listed in Table 4.

TABLE 2

| | Composition of cellulose acylate film | | | | | | | |
|---|---|---|---|---|---|---|---|---|
| | Cellulose | | | Nitrogen-containing | | Polarizing element | | |
| | acylate | Plasticizer | | aromatic compound | | durability modifier | | Film formation |
| | Acyl | | Amount | | Amount | | Amount | Drying |
| | substitution | | [% by | | [% by | | [% by | Temperature |
| | degree | Kinds | mass] | Kinds | mass] | Kinds | mass] | [° C.] |
| Ex. 1 | 2.88 | #1 | 15 | — | — | — | — | 120 |
| Ex. 2 | 2.88 | #2 | 15 | — | — | — | — | 120 |
| Ex. 3 | 2.88 | #3 | 15 | — | — | — | — | 120 |
| Ex. 4 | 2.88 | #4 | 15 | — | — | — | — | 120 |
| Ex. 5 | 2.88 | #5 | 15 | — | — | — | — | 120 |
| Ex. 6 | 2.88 | #6 | 15 | — | — | — | — | 120 |
| Ex. 7 | 2.88 | #7 | 15 | — | — | — | — | 120 |
| Ex. 8 | 2.88 | #8 | 15 | — | — | — | — | 120 |
| Ex. 9 | 2.88 | #9 | 15 | — | — | — | — | 120 |
| Ex. 10 | 2.88 | #10 | 15 | — | — | — | — | 120 |
| Ex. 11 | 2.88 | #11 | 15 | — | — | — | — | 120 |
| Ex. 12 | 2.88 | #12 | 15 | — | — | — | — | 120 |
| Ex. 13 | 2.88 | #13 | 15 | — | — | — | — | 120 |
| Ex. 14 | 2.88 | #14 | 15 | — | — | — | — | 120 |
| Ex. 15 | 2.94 | #3 | 15 | — | — | — | — | 120 |
| Ex. 16 | 2.86 | #3 | 25 | — | — | — | — | 120 |
| Ex. 17 | 2.86 | #3 | 30 | Compound B | 2 | — | — | 120 |
| Ex. 18 | 2.86 | #3 | 40 | Compound B | 3 | — | — | 120 |
| Ex. 19 | 2.86 | #3 | 45 | — | — | — | — | 120 |
| Ex. 20 | 2.88 | TPP/BDP | 12 | Compound C | 3 | — | — | 180 |
| Ex. 21 | 2.88 | #1 | 15 | — | — | Compound D | 2 | 120 |
| Ex. 22 | 2.88 | #1 | 15 | — | — | Compound D | 4 | 120 |
| Ex. 23 | 2.86 | #1 | 15 | — | — | Compound E | 2 | 120 |
| Ex. 24 | 2.86 | #1 | 15 | — | — | Compound E | 4 | 120 |
| Ex. 25 | 2.88 | #15 | 15 | — | — | — | — | 120 |
| Ex. 26 | 2.88 | #16 | 15 | — | — | — | — | 120 |
| Ex. 27 | 2.88 | #17 | 15 | — | — | — | — | 120 |
| Ex. 28 | 2.88 | #18 | 15 | — | — | — | — | 120 |
| Ex. 29 | 2.88 | #19 | 15 | — | — | — | — | 120 |
| Ex. 30 | 2.88 | #20 | 15 | — | — | — | — | 120 |
| Ex. 31 | 2.88 | #22 | 15 | — | — | — | — | 120 |
| Ex. 32 | 2.88 | #23 | 15 | — | — | — | — | 120 |
| Comp. Ex. 1 | 2.86 | #3 | 25 | — | — | — | — | 120 |
| Comp. Ex. 2 | 2.86 | #3 | 15 | — | — | — | — | 120 |
| Comp. Ex. 3 | 2.86 | #3 | 10 | — | — | — | — | 120 |
| Comp. Ex. 4 | 2.86 | #3 | 15 | — | — | — | — | 120 |
| Comp. Ex. 5 | 2.88 | #3 | 15 | — | — | — | — | 90 |
| Comp. Ex. 6 | 2.81 | #3 | 15 | — | — | — | — | 120 |
| Comp. Ex. 7 | 2.94 | #3 | 25 | — | — | — | — | 120 |
| Comp. Ex. 8 | 2.88 | #3 | 15 | Compound A | 1 | — | — | 120 |
| Comp. Ex. 9 | 2.86 | #3 | 25 | — | — | — | — | 120 |
| Comp. Ex. 10 | 2.88 | #3 | 15 | — | — | Compound F | 4 | 90 |

TABLE 3

| | Performance and evaluation of cellulose acylate film | | | | | | | | |
|---|---|---|---|---|---|---|---|---|---|
| | | | | | | | Dimensional change rate | | |
| | | | | Retardation after 60° C., | | | after 60° C., 90%, 24 h [%] | | |
| | | | | 90%, 48 h | | | | Direction | |
| | | Retardation at initial | | Rth | | Rth | | orthogonal | |
| | | time | | (440 W, 30%) − | | (440 W, 30%) − | Sound | to the sound | Winding |
| | | Rth | Rth | Rth | Rth | Rth | speed | speed | quality or |
| | Thickness | (440 W, 60%) | (550 W, 60%) | (550 W, 30%) | (440 W, 30%) | (440 W, 80%) | maximum | maximum | production |
| | [nm] | [nm] | [nm] | [nm] | [nm] | [nm] | direction | direction | suitability |
| Ex. 1 | 20 | −7 | −2 | −4 | 1 | 8 | 0.0 | 0.0 | A |
| Ex. 2 | 20 | −7 | −2 | −4 | 1 | 8 | 0.0 | 0.0 | A |
| Ex. 3 | 20 | −7 | −2 | −4 | 1 | 8 | 0.0 | 0.0 | A |
| Ex. 4 | 20 | −7 | −2 | −4 | 1 | 8 | 0.0 | 0.0 | A |
| Ex. 5 | 20 | −7 | −2 | −4 | 1 | 8 | 0.0 | 0.0 | A |
| Ex. 6 | 20 | −7 | −2 | −4 | 1 | 8 | 0.0 | 0.0 | A |
| Ex. 7 | 20 | −8 | −3 | −4 | 0 | 8 | 0.0 | 0.0 | A |
| Ex. 8 | 20 | −8 | −3 | −4 | 0 | 8 | 0.0 | 0.0 | A |
| Ex. 9 | 20 | −9 | −4 | −4 | −1 | 7 | 0.0 | −0.1 | A |
| Ex. 10 | 20 | −9 | −4 | −4 | −1 | 7 | 0.0 | −0.1 | A |
| Ex. 11 | 20 | −9 | −4 | −4 | −1 | 7 | 0.0 | −0.1 | A |
| Ex. 12 | 20 | −11 | −6 | −4 | −3 | 7 | −0.1 | −0.1 | A |
| Ex. 13 | 20 | −11 | −6 | −4 | −3 | 7 | −0.1 | −0.1 | A |
| Ex. 14 | 20 | −7 | −2 | −4 | 1 | 8 | −0.1 | −0.1 | A |
| Ex. 15 | 20 | −14 | −10 | −4 | −6 | 9 | 0.0 | 0.0 | A |
| Ex. 16 | 41 | −21 | −12 | −8 | −13 | 13 | −0.1 | 0.0 | A |
| Ex. 17 | 40 | −8 | 0 | −8 | −15 | 7 | −0.1 | −0.1 | A |
| Ex. 18 | 40 | −7 | 1 | −6 | −8 | 4 | −0.1 | −0.1 | A |
| Ex. 19 | 40 | −20 | −12 | −6 | −14 | 5 | −0.1 | −0.1 | B |
| Ex. 20 | 25 | 2 | 5 | −3 | 1 | 15 | −0.1 | −0.1 | B |
| Ex. 21 | 20 | −10 | −5 | −3 | −2 | 8 | 0.0 | 0.0 | A |
| Ex. 22 | 20 | −13 | −9 | −3 | −5 | 8 | 0.0 | 0.0 | A |
| Ex. 23 | 40 | −15 | −9 | −3 | −3 | 13 | 0.0 | 0.0 | A |
| Ex. 24 | 40 | −20 | −14 | −3 | −8 | 13 | 0.0 | 0.0 | A |
| Ex. 25 | 20 | −10 | −5 | −4 | −2 | 7 | −0.1 | −0.1 | A |
| Ex. 26 | 20 | −9 | −4 | −4 | −1 | 7 | 0.0 | 0.0 | A |
| Ex. 27 | 20 | −5 | 0 | −4 | 3 | 9 | 0.0 | 0.0 | A |
| Ex. 28 | 20 | −4 | 1 | −4 | 4 | 10 | 0.0 | 0.0 | B |
| Ex. 29 | 20 | −3 | 2 | −4 | 5 | 10 | 0.0 | 0.0 | B |
| Ex. 30 | 20 | −5 | 0 | −4 | 3 | 9 | 0.0 | 0.0 | A |
| Ex. 31 | 20 | −5 | 0 | −4 | 3 | 9 | 0.0 | 0.0 | A |
| Ex. 32 | 20 | −5 | 0 | −4 | 3 | 9 | 0.0 | 0.0 | A |
| Comp. | 60 | −30 | −17 | −12 | −18 | 18 | 0.0 | 0.0 | A |
| Ex. 1 | | | | | | | | | |
| Comp. | 41 | −13 | −4 | −9 | −1 | 19 | −0.1 | −0.1 | A |
| Ex. 2 | | | | | | | | | |
| Comp. | 40 | −2 | 7 | −13 | 4 | 25 | −0.1 | −0.1 | A |
| Ex. 3 | | | | | | | | | |
| Comp. | 10 | −3 | −1 | −2 | 1 | 4 | −0.35 | −0.35 | B |
| Ex. 4 | | | | | | | | | |
| Comp. | 20 | −4 | 0 | −4 | 4 | 8 | −0.35 | −0.35 | A |
| Ex. 5 | | | | | | | | | |
| Comp. | 25 | 7 | 12 | −5 | 15 | 12 | −0.1 | −0.1 | A |
| Ex. 6 | | | | | | | | | |
| Comp. | 40 | −37 | −29 | −8 | −29 | 12 | −0.1 | −0.1 | A |
| Ex. 7 | | | | | | | | | |
| Comp. | 25 | 3 | 8 | −2 | 12 | 10 | −0.1 | −0.1 | A |
| Ex. 8 | | | | | | | | | |
| Comp. | 50 | −25 | −14 | −10 | −15 | 15 | 0.0 | 0.0 | A |
| Ex. 9 | | | | | | | | | |
| Comp. | 20 | −10 | −6 | −3 | −3 | 8 | −0.35 | −0.35 | A |
| Ex. 10 | | | | | | | | | |

TABLE 4

| | Evaluation on liquid crystal display device | | | |
|---|---|---|---|---|
| | | Level of light | Level of light | Polarizer evaluation |
| | Level of light | unevenness having | unevenness having | Change amount of the |
| | unevenness in | circular shape or | circular shape or | orthogonal transmittance |
| | inclined | elliptical shape in front | elliptical shape in | after 60° C., 95%, |
| | direction at | surface direction after | inclined direction after | 900 h at 410 nm [%]: |
| | initial time | thermal treatment | thermal treatment | ΔT/T before aging) |
| Ex. 1 | S | S | S | 15 |
| Ex. 2 | S | S | S | 15 |
| Ex. 3 | S | S | S | 15 |
| Ex. 4 | S | S | S | 15 |
| Ex. 5 | S | S | S | 15 |
| Ex. 6 | S | S | S | 15 |
| Ex. 7 | S | S | S | 15 |
| Ex. 8 | S | S | S | 15 |
| Ex. 9 | S | S | S | 15 |
| Ex. 10 | S | S | S | 15 |
| Ex. 11 | S | S | S | 15 |
| Ex. 12 | S | S | S | 15 |
| Ex. 13 | S | S | S | 15 |
| Ex. 14 | S | S | S | 15 |
| Ex. 15 | A | A | A | 15 |
| Ex. 16 | A | B | B | 16 |
| Ex. 17 | S | A | A | 16 |
| Ex. 18 | A | B | A | 18 |
| Ex. 19 | B | B | B | 18 |
| Ex. 20 | B | B | B | 15 |
| Ex. 21 | S | S | S | 9 |
| Ex. 22 | A | A | A | 6 |
| Ex. 23 | A | B | B | 9 |
| Ex. 24 | A | B | B | 6 |
| Ex. 25 | S | S | S | 15 |
| Ex. 26 | S | S | S | 15 |
| Ex. 27 | S | S | A | 15 |
| Ex. 28 | A | S | A | 15 |
| Ex. 29 | A | S | A | 15 |
| Ex. 30 | S | S | A | 16 |
| Ex. 31 | S | S | A | 16 |
| Ex. 32 | S | S | A | 15 |
| Comp. Ex. 1 | C | D | D | 16 |
| Comp. Ex. 2 | A | D | D | 15 |
| Comp. Ex. 3 | A | D | D | 15 |
| Comp. Ex. 4 | A | D | D | 15 |
| Comp. Ex. 5 | A | D | D | 15 |
| Comp. Ex. 6 | C | D | D | 15 |
| Comp. Ex. 7 | C | D | D | 16 |
| Comp. Ex. 8 | A | D | D | 15 |
| Comp. Ex. 9 | A | D | B | 16 |
| Comp. Ex. 10 | A | D | B | 6 |

As listed in Tables 2 to 4 above, it was understood that the optical film of the present invention was thin, Rth at a wavelength of 440 nm after the thermal treatment was in the specific range, the change in humidity dependency of Rth at a wavelength of 440 nm after the thermal treatment was small, and the thermal contraction rate before and after the thermal treatment was small. Further, it was understood that the optical film of the present invention was capable of suppressing light unevenness having a circular shape or an elliptical shape generated on the display surface after the wet-heat treatment when the optical film was applied to a thin liquid crystal display device.

Meanwhile, it was understood that light unevenness having a circular shape or an elliptical shape was generated on the display surface after the wet-heat thermal treatment in regard to the optical film of Comparative Examples 1 and 9, whose film thickness exceeded the upper limit of the present invention.

It was understood that light unevenness having a circular shape or an elliptical shape was generated on the display surface after the wet-heat thermal treatment at the time when the optical film was applied to a thin liquid crystal display device in regard to the optical film of Comparative Examples 2 and 3, whose humidity dependency change of Rth at a wavelength of 440 nm after the wet-heat thermal treatment exceeded the upper limit of the present invention.

It was understood that light unevenness having a circular shape or an elliptical shape was generated on the display surface after the wet-heat thermal treatment at the time when the optical film was applied to a thin liquid crystal display device in regard to the optical film of Comparative Example 4, whose film thickness was less than the lower limit of the present invention and thermal contraction rate after the wet-heat thermal treatment exceeded the upper limit of the present invention.

It was understood that light unevenness having a circular shape or an elliptical shape was generated on the display surface after the wet-heat thermal treatment at the time when the optical film was applied to a thin liquid crystal display device in regard to the optical film of Comparative Example 5, whose thermal contraction rate before and after the wet-heat thermal treatment exceeded the upper limit of the present invention.

It was understood that light unevenness having a circular shape or an elliptical shape was generated on the display surface after the wet-heat thermal treatment at the time when the optical film was applied to a thin liquid crystal display device in regard to the optical film of Comparative Examples 6 and 8, whose Rth at a wavelength of 440 nm after the wet-heat thermal treatment exceeded the upper limit of the present invention.

It was understood that light unevenness having a circular shape or an elliptical shape was generated on the display surface after the wet-heat thermal treatment at the time when the optical film was applied to a thin liquid crystal display device in regard to the optical film of Comparative Example 7, whose Rth at a wavelength of 440 nm after the wet-heat thermal treatment was lower than the lower limit of the present invention.

In addition, it was understood that the optical film of Examples 21 to 24, to which a polarizing element durability modifier was added had less change in polarizing element transmittance after the thermal treatment for a long period of time and had excellent polarizing element durability.

The present disclosure relates to the subject matter contained in Japanese Patent Application No. 109769/2012 filed on May 11, 2012 and in Japanese Patent Application No. 052316/2013 filed on Mar. 14, 2013, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film,
wherein a film thickness is in a range of 15 μm to 45 μm,
Rth (440 W, 30% RH) and “Rth (440 W, 30% RH)−Rth (440 W, 80% RH)” of the optical film to which a wet-heat treatment is applied at 60° C. and at a relative humidity of 90% for 48 hours satisfy the following expressions (1) and (2), and
a dimensional change rate of the film to which a treatment is applied at 60° C. and at a relative humidity of 90% for 24 hours is ±0.3% or less;
−20 nm≦Rth(440 W,30% RH)≦5 nm Expression (1)
0 nm≦Rth(440 W,30% RH)−RH(440 W,80% RH)≦18 nm, Expression (2)
here, in Expressions (1) and (2), Rth (440 W, 30% RH) represents a retardation value in a film thickness direction at a wavelength of 440 nm measured at 25° C. and at a relative humidity of 30% and Rth (440 W, 80% RH) represents a retardation value in the film thickness direction at a wavelength of 440 nm measured at 25° C. and at a relative humidity of 80%.

2. The optical film according to claim 1, wherein “Rth (440 W, 30% RH)−Rth (550W, 30% RH)” of the optical film to which the wet-heat treatment is applied at 60° C. and at a relative humidity of 90% for 48 hours satisfies the following expression (3);
Rth(440 W,30% RH)−Rth(550 W,30% RH)<0 nm, Expression (3)
in the expression (3), Rth (440 W, 30% RH) represents a retardation value in the film thickness direction at a wavelength of 440 nm measured at 25° C. and at a relative humidity of 30% and Rth (550 W, 80% RH) represents a retardation value in the film thickness direction at a wavelength of 550 nm measured at 25° C. and at a relative humidity of 80%.

3. The optical film according to claim 1, wherein the following expression (4) is satisfied;
−15 nm≦Rth(550 W,60% RH)≦10 nm, Expression (4)
in the expression (4), Rth (550 W, 60% RH) represents a retardation value in the film thickness direction at a wavelength of 550 nm measured at 25° C. and at a relative humidity of 60%).

4. The optical film according to claim 1, wherein the following expression (5) is satisfied;
−28 nm≦Rth(440 W,60% RH)≦8 nm, Expression (5)
in the expression (5), Rth (440 W, 60% RH) represents a retardation value in the film thickness direction at a wavelength of 440 nm measured at 25° C. and at a relative humidity of 60%).

5. The optical film according to claim 1, wherein the optical film contains at least cellulose acylate.

6. The optical film according to claim 5, wherein a degree of acyl substitution of the cellulose acylate is in a range of 2.82 to 2.95.

7. The optical film according to claim 5, wherein the cellulose acylate is cellulose acetate.

8. The optical film according to claim 5, wherein a plasticizer is contained in a range of 10% by mass to 40% by mass with respect to the cellulose acylate.

9. The optical film according to claim 8, wherein the plasticizer contains polycondensed ester of dicarboxylic acid and diol.

10. The optical film according to claim 9, wherein the polycondensed ester is polycondensed ester of aliphatic dicarboxylic acid and aliphatic diol.

11. The optical film according to claim 10, wherein the number of carbon atoms of the aliphatic dicarboxylic acid is 3 to 8.

12. The optical film according to claim 11, wherein the number of carbon atoms of the aliphatic dicarboxylic acid is 4 to 6.

13. The optical film according to claim 10, wherein the number of carbon atoms of the aliphatic diol is 2 to 6.

14. The optical film according to claim 13, wherein the number of carbon atoms of the aliphatic diol is 2 to 4.

15. The optical film according to claim 9, wherein a hydroxyl value of the polycondensed ester is in a range of 0 mgKOH/g to 250 mgKOH/g.

16. The optical film according to claim 15, wherein each of both terminals of the polycondensed ester is sealed with monocarboxylic acid.

17. The optical film according to claim 16, wherein the monocarboxylic acid is aliphatic monocarboxylic acid having 2 to 22 carbon atoms.

18. The optical film according to claim 17, wherein the number of carbon atoms of the aliphatic monocarboxylic acid is 2 or 3.

19. The optical film according to claim 1, wherein a nitrogen-containing aromatic compound is contained.

20. The optical film according to claim 1, wherein a polarizing element durability modifier is contained.

21. A polarizer comprising:
a polarizing element; and
the optical film according to claim 1, which is arranged on at least one side of the polarizing element.

22. A liquid crystal display device comprising at least one sheet of the polarizer according to claim 21.

23. The liquid crystal display device according to claim 22,
wherein the liquid crystal display device is an IPS liquid crystal display device, and
a liquid crystal cell satisfies the following expression (6);
250 nm≦Δnd(550)≦350 nm, Expression (6)
in Expression (6), Δnd (550) represents the product of refractive index anisotropy (Δn) and a cell gap (d) of a rod-shaped liquid crystalline molecule of a liquid crystal cell at a wavelength 550 nm.
